(19) United States
(12) Patent Application Publication
(10) Pub. No.: US 2007/0065602 A1
(43) Pub. Date: Mar. 22, 2007

(54) Optical film, polarizing plate and image display device

(75) Inventors: Kenichi Fukuda, Kanagawa (JP); Hiroyuki Yoneyama, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Minami-Ashigara-shi (JP)

(21) Appl. No.: 11/522,890

(22) Filed: Sep. 19, 2006

(30) Foreign Application Priority Data
Sep. 21, 2005 (JP) 2005-274162

(51) Int. Cl. C09K 19/00

(52) U.S. Cl. 428/1.1; 428/1.31

(57) ABSTRACT

A light-diffusing film comprises: a transparent plastic film substrate; and a light-diffusing layer comprising at least one kind of active energy ray-cured resin and a light-diffusing particle, wherein a contact angle with water on a surface, on the side opposite to the transparent plastic film substrate, of the light-diffusing layer is 90° or more.

### BACKGROUND OF THE INVENTION

1. Field of the Invention

The present invention relates to an optical film having an antifouling light-diffusing layer, a polarizing plate using such an optical film, and an image display device. More specifically, the present invention relates to a light-diffusing (hardcoat) film formed from an active energy ray-curable composition comprising a curable resin, a light-diffusing particle and a specific compound having a silicone group and a polymerizable group, and also relates to a polarizing plate using the same and an image display device.

2. Description of the Related Art

In various image display devices such as liquid crystal display device (LCD), plasma display panel (PDP), electroluminescence display (ELD) and cathode ray tube display device (CRT), a light-diffusing film comprising a transparent plastic film substrate having stacked thereon a light-diffusing layer containing a light-diffusing particle is disposed on the display surface so that reduction in the contrast due to reflection of outside light or projection of an image can be prevented by the effect of surface scattering property or the viewing angle can be enlarged by the effect of internal scattering property (particularly, in a liquid crystal display device having mounted thereon an optical compensation film, for enlarging the viewing angle in the downward direction (see, for example, JP-A-2005-77860)). Accordingly, the light-diffusing film is required to have high physical strength (e.g., scratch resistance) in addition to high visibility-improving effect.

With recent price-reduction of a liquid crystal television and the like, an image display device having mounted thereon a light-diffusing film is rapidly spread and becomes accessible to general people. As a result, the light-diffusing film mounted is increasingly exposed to various environments. For example, direct touching with fingers or mischievous play by young children occurs on many occasions. This increase in the opportunity of being directly touched by a person leads to an abrupt increase in the opportunity allowing for attachment of contamination such as fingerprint, sign pen, cosmetic and sweat.

In recent years, as an image display device having mounted thereon a light-diffusing film, such as liquid crystal television, is spread, there is a demand on the market for a liquid crystal display device ensuring that the price is lower, the visibility is good, the physical strength is high and the contamination is difficult to attach (or easy to remove). Accordingly, development of a light-diffusing film allowing for less attachment of contamination and capable of sustaining the contamination attachment-preventing property, exhibiting high scratch resistance and being produced at a low cost, is demanded.

JP-A-2001-91707 discloses a method of imparting an antifouling property by providing a low refractive index layer containing a heat-curable fluorine polymer and having an optical film thickness of λ/4 on a light-diffusing layer containing a light-diffusing particle. However, this method has a limit in view of reduction in the cost, because the coating, drying and curing of a curable composition must be repeated twice and the productivity is significantly low.

In JP-A-2003-335984 and JP-A-2005-111756, the present inventors are disclosing a method for producing a hardcoat film assured of less attachment of contamination and capable of sustaining the contamination attachment resistance and exhibiting high physical strength. However, light-diffusing property for improving the visibility is not imparted to the hardcoat film. In order to improve the visibility, surface scattering property is imparted by forming surface irregularities, but the formation of surface irregularities causes worsening of the antifouling property or scratch resistance. In these publications, a technique capable of satisfying both the visibility and the antifouling property or scratch resistance is not disclosed.

JP-A-2005-219223 discloses an antifouling layer and a production method of the antifouling layer, where even when the antifouling layer is formed on an antiglare layer having irregularities on the surface thereof, excellent antifouling property is repeatedly exhibited. However, the antifouling layer is provided separately from the antiglare layer and a special apparatus is necessary due to use of an atmospheric plasma method, as a result, the productivity is significantly low and there is a limit in view of reduction in the cost.

### SUMMARY OF THE INVENTION

An object of the present invention is to provide an optical film having high visibility, suitability for mass production, excellent scratch resistance, and high and sustained antifouling property. Another object of the present invention is to provide a polarizing plate and an image display device, which are equipped with the optical film.

As a result of intensive investigations, the present inventors have found that when a light-diffusing layer containing an active energy ray-curable resin and a light-diffusing fine particle is stacked on a substrate, a light-diffusing film assured of high surface hardness and excellent scratch resistance and capable of continuously exerting good antifouling property can be prepared.

That is, the above-described objects can be attained by the use of the following constitutions and compounds.

1. A light-diffusing film comprising: a transparent plastic film substrate; and a light-diffusing layer comprising at least one kind of active energy ray-cured resin and a light-diffusing particle, wherein a contact angle with water on a surface, on the side opposite to the transparent plastic film substrate, of the light-diffusing layer is 90° or more.

2. The light-diffusing film, wherein the contact angle with water of the surface is 95° or more.

3. The light-diffusing film, wherein the contact angle with water of the surface is 100° or more.

4. The light-diffusing film as described in any one of items 1 to 3, wherein a compound having at least one of a fluorine atom and a silicon atom and having an active energy ray-polymerizable group, the compound being localized in vicinity to the surface of the light-diffusing layer, is connected to the active energy ray-cured resin by a reaction of the active energy ray-polymerizable group.

5. The light-diffusing film as described in item 4, wherein the compound contains a perfluoroalkyl group and an active energy ray-polymerizable group.

6. The light-diffusing film as described in item 4 or 5, wherein the active energy ray-polymerizable group contained in the compound is a group containing a (meth)acrylate group or an epoxy group.

7. The light-diffusing film as described in item 4 or 6, wherein the compound having the silicon atom and having an active energy-ray polymerizable group is a compound having a polydimethylsiloxane skeleton.

8. The light-diffusing film as described in item 7, wherein the compound having at least one of a fluorine atom and a silicon atom and having an active energy ray-polymerizable group is represented by formula (1): 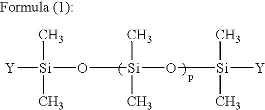
wherein two Ys each independently represents a substituent, p represents an integer of 10 to 1,500.

9. The light-diffusing film as described in item 8, wherein, in the formula (1), from 10 to 25% of “the two Ys and methyl groups connected to Si atoms” are substituted by an alkyl group containing a (meth)acrylate group.

10. The light-diffusing film as described in item 9, wherein a substituted ratio of the two Ys and the methyl groups is from 13 to 22%.

11. The light-diffusing film as described in item 9, wherein a substituted ratio of the two Ys and the methyl groups is from 16 to 19%.

12. The light-diffusing film as described in any one of items 8 to 11, wherein the compound having a polydimethylsiloxane skeleton is an active energy ray-curable silicone resin having a silicon content of 23 to 32 wt %.

13. The light-diffusing film as described in any one of items 8 to 12, wherein the compound having a polydimethylsiloxane skeleton is used in an amount of 0.001 to 0.5 mass % based on the total amount of an active ray-curable resin used for forming the active energy ray-cured resin.

14. The light-diffusing film as described in any one of items 1 to 13, wherein the photoelectron spectral intensity ratio Si/C and/or F/C in the surface ESCA (X-ray electron spectroscopy for chemical analysis) of the light-diffusing film is 0.6 or more.

15. The light-diffusing film as described in item 14, wherein the fluorine atom and/or silicon atom segregates on the surface of the light-diffusing film and in the ESCA (X-ray electron spectroscopy for chemical analysis) of the outermost surface and a layer 100 nm lower than the outermost surface, the photoelectron spectral intensity ratio Si/C and/or F/C on the outermost surface is as large as 5 times or more that in the 100 nm lower layer.

16. The light-diffusing film as described in any one of items 1 to 15, wherein the light-diffusing layer comprises from 3 to 35 parts by mass of a light-diffusing particle per 100 parts by mass in total of the active energy ray-curable resins.

17. The light-diffusing film as described in any one of items 1 to 16, wherein the average film thickness of the light-diffusing layer is from 8.0 to 40.0 μm.

18. The light-diffusing film as described in any one of items 1 to 16, wherein the average film thickness of the light-diffusing layer is from 12.0 to 35.0 μm.

19. The light-diffusing film as described in any one of items 1 to 16, wherein the average film thickness of the light-diffusing layer is from 20.0 to 30.0 μm.

20. The light-diffusing film as described in any one of items 1 to 19, wherein the pencil hardness with a load of 4.9N is 3H or more.

21. The light-diffusing film as described in any one of items 1 to 19, wherein the pencil hardness with a load of 4.9N is 4H or more.

22. The light-diffusing film as described in any one of items 1 to 19, wherein the pencil hardness with a load of 4.9N is 5H or more.

23. The light-diffusing film as described in any one of items 1 to 22, wherein when the cured layer surface is rubbed with a #0000 steel wool in 10 reciprocations while applying a load of 1.96 N/cm², a rubbing mark is not observed with an eye.

24. The light-diffusing film as described in any one of items 1 to 23, wherein the average particle diameter of the light-diffusing particle contained in the light-diffusing layer is from 1 to 15 μm.

25. The light-diffusing film as described in any one of items 1 to 23, wherein the average particle diameter of the light-diffusing particle contained in the light-diffusing layer is from 3 to 12 μm.

26. The light-diffusing film as described in any one of items 1 to 23, wherein the average particle diameter of the light-diffusing particle contained in the light-diffusing layer is from 5 to 10 μm.

27. The light-diffusing film as described in any one of items 1 to 26, wherein the surface haze is 15% or less.

28. The light-diffusing film as described in any one of items 1 to 26, wherein the surface haze is 10% or less.

29. The light-diffusing film as described in any one of items 1 to 26, wherein the surface haze is 5% or less.

30. The light-diffusing film as described in any one of items 1 to 29, wherein the internal haze is from 10 to 70%.

31. The light-diffusing film as described in any one of items 1 to 29, wherein the internal haze is from 15 to 55%.

32. The light-diffusing film as described in any one of items 1 to 29, wherein the internal haze is from 20 to 40%.

33. The light-diffusing film as described in any one of items 1 to 32, wherein the surface roughness (Ra) of the light-diffusing film is from 0.025 to 0.5 μm.

34. A polarizing plate comprising: a polarizing film; and two protective films on both sides of the polarizing film, wherein one of the two protective films is the light-diffusing film described in any one of items 1 to 33.

35. A polarizing plate comprising: a polarizing film; and two protective films on both sides of the polarizing film, wherein one of the two protective films is the light-diffusing film described in any one of items 1 to 33 and the other one of the two protective films is an optical compensation film having optical anisotropy.

36. An image display device having disposed on the image display surface thereof the light-diffusing film described in any one of items 1 to 33 or the polarizing plate described in item 34 or 35.

37. The image display device as described in item 36, wherein the image display device is a transmissive, reflective or transflective liquid crystal display device in any one mode of TN, STN, IPS, VA and OCB.

### DETAILED DESCRIPTION OF THE INVENTION

The preparation method and the like of the light-diffusing film (hereinafter, “light-diffusing film” is referred to as “optical film”, unless otherwise instructed) of the present invention are described below.

In the present invention, when a numerical value denotes a physical property value, a characteristic value or the like, the term “from (numerical value 1) to (numerical value 2)” means “(numerical value 1) or more and (numerical value 2) or less”.

<Layer Construction>

As for the optical film of the present invention, a layer construction where a light-diffusing layer is formed on a transparent plastic film substrate may be used. Between the transparent plastic film substrate and the light-diffusing layer, the following layers may be provided, if desired.

Examples of the layer which may be provided between the transparent plastic film substrate and the light-diffusing layer include an antistatic layer (when, for example, reduction in the surface resistivity from the display side is required or attachment of dust to the surface or the like becomes a problem), a hardcoat layer (when hardness is insufficient only by the above-described constitution), a moisture-proofing layer, an adhesion-improving layer and an interference fringe-preventing layer (when a refractive index difference of 0.03 or more is present between the substrate and the light-diffusing layer).

In the light-diffusing film of the present invention, the haze attributable to surface scattering (hereinafter referred to as “surface haze”) is preferably 15% or less, more preferably 10% or less, still more preferably 8% or less, particularly preferably 5% or less. If the surface haze is 15% or less, white blurring when displaying the image on the display is low, which can reach the objective level of the present invention.

Also, in the light-diffusing film of the present invention, the haze attributable to internal scattering (hereinafter referred to as “internal haze”) is preferably from 10 to 70%, more preferably from 15 to 55%, still more preferably from 20 to 40%. When the internal haze is in this range, a light-diffusing film ensuring less letter blurring and appropriate scattering is obtained.

<Light-Diffusing Layer>

The light-diffusing layer is formed for the purpose of imparting surface or internal scattering property to the film and preferably imparting hardcoat property so as to enhance the scratch resistance of the film. Accordingly, the light-diffusing layer comprises a curable resin capable of imparting hardcoat property and a light-diffusing particle for imparting light-diffusing property. The curable resin is preferably an active energy ray-polymerizable resin and in this case, the resin contains an active energy ray-polymerizable group capable of polymerizing under irradiation with active energy rays.

[Impartation of Antifouling Property]

In view of the antifouling property, the contact angle with water on the light-diffusing layer (hardcoat layer) surface is 90° or more, preferably 95° or more, still more preferably 100° or more. In order to cause the light-diffusing layer surface to have a contact angle with water in this range, a compound containing either a fluorine atom or a silicon atom, that is, a silicon-based or fluorine-based antifouling agent, can be incorporated into the curable composition for forming the light-diffusing layer.

Preferred examples of the silicon-based compound include those having a basic skeleton containing a dimethylsilyloxy unit represented by formula (1), namely a polydimethylsiloxane skeleton, as a repeating unit, where a plurality of compound chains are contained and have a substituent Y at the terminal and/or on the side chain. The compound chain containing dimethylsilyloxy as a repeating unit may contain a structural unit other than dimethylsilyloxy. A plurality of substituents, which may be the same or different, are preferably present. Preferred examples of the substituent include a group containing an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group or an amino group.

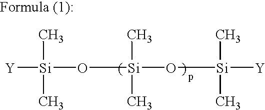

In formula (1), Y represents a substituent, and p represents an integer of 10 to 1,500.

The silicon atom content of the silicone-based compound is preferably 18 mass % or more, more preferably from 23 to 32 mass %, still more preferably from 26 to 31 mass %, and most preferably from 29 to 31 mass %.

If the silicon content exceeds this range, the problem that the compound localizes only on the surface of the coating film to reduce the density of the bonding group on the surface of the coating film, which cause failing in sustaining the antifouling property, may arise and, further, non-uniformity in the surface composition may occur. If the silicon content is less than the above-described range, the contact angle on the surface cannot be increased to the desired range and the antifouling property is not brought out from the initial stage.

The silicone-based compound of the present invention has an active energy ray-polymerizable group. When an active energy ray-polymerizable group is introduced into the silicone-based compound, the silicone-based compound is reacted to connect an active energy ray-curable resin as the binder and therefore, can be firmly fixed in the light-diffusing layer.

In the present invention, by the control of the silicon content in the silicone-based compound and the introduction of a polymerizable group, both good antifouling surface and prevention of the antifouling compound from elimination due to physical contact can be achieved and a sustained antifouling surface can be obtained.

Examples of the active energy ray-polymerizable group contained in the silicone-based compound of the present invention include a radical polymerizable double bond such as acryl group, and a cationic polymerizable group such as epoxy group. The particularly preferred active energy ray-polymerizable group is a radical polymerizable acrylate or methacrylate group, with the acrylate group being most preferred.

As for the structure where an active energy ray-polymerizable group is introduced into the silicone-based compound, the following structures (1) to (4) described in JP-A-2003-202407, paragraphs [0012] to [0014], are preferred, and among them, (1) the side-chain type and (2) the side-chain both-terminal type are more preferred.

(1) Side-Chain Type

A modified silicone oil in which an active energy ray-polymerizable group is introduced into the side chain of the polysiloxane

(2) Both-Terminal Type

A modified silicone oil in which an active energy ray-polymerizable group is introduced into both terminals of the polysiloxane

(3) One-Terminal Type

A modified silicone oil in which an active energy ray-polymerizable group is introduced into one terminal of the polysiloxane

(4) Side-Chain Both-Terminal Type

A modified silicone oil in which an active energy ray-polymerizable group is introduced into the side chain and both terminals of the polysiloxane.

The compound having a polydimethylsiloxane skeleton containing an active energy ray-polymerizable group is preferably represented by formula (1) wherein from 10 to 25% of the two Ys and methyl groups connected to Si atoms are substituted by an alkyl group containing a (meth)acrylate group.

The ratio at which the methyl group is substituted by an alkyl group containing an active energy ray-polymerizable group is preferably from 13 to 22% and most preferably from 16 to 19%. If the ratio of the active energy ray-polymerizable group is less than this range, the bonding to a hardcoat constituent material except for a silicone resin becomes weak and the antifouling property deteriorates due to rubbing or wiping off, whereas if the ratio of the active energy ray-polymerizable group exceeds the above-described range, the silicon content cannot be resultantly elevated to the desired level and the antifouling property is not exerted.

The alkyl group containing a (meth)acrylate group is preferably a group represented by —(CH₂)_{q}—O—CO—C(X)═CH₂ (wherein q represents an integer of 2 to 8, preferably 3 or 4, and X represents a hydrogen atom or a methyl group).

Examples of the active energy ray-curable silicone resin include UMS-182 produced by Chisso Corporation. Also, for example, X-22 or X-24 produced by Shin-Etsu Chemical Co., Ltd., GS1015 produced by Toagosei Chemical Industry Co., Ltd., or UMS-992 produced by Chisso Corp, or RMS-044 or RMS-083 by Gelest, Inc. may be adjusted to the Si content of the present invention by appropriately changing the copolymerization compositional ratio or the degree of acryl modification.

Specific examples of the cationic polymerizable silicone compound include KF-105, X-22-163A, X-22-163B, X-22-163C, X-22-164C, X-22-173DX, KF-1001, KF-1001, KF-101, X-22-169AS, X-22-169B, KF-102, X-22-3667 and X-22-4741 (produced by Shin-Etsu Chemical Co., Ltd.).

Specific examples of the commercially available cationic polymerizable polysiloxane compound are described in JP-A-2004-314468, paragraph [0022], and the commercially available products described therein may also be preferably used in the present invention.

The compound having a polydimethylsiloxane skeleton for use in the present invention can be synthesized by the methods described in JP-A-7-70246, JP-A-7-76611, JP-A-9-3392 and JP-A-2001-226487.

The molecular weight of the active energy ray-curable silicone resin may be from 1,000 to 100,000 but is preferably from 2,000 to 50,000, more preferably from 2,500 to 20,000.

The coated amount of the active energy ray-curable silicone resin is from 0.4 to 100 mg/m², preferably from 1 to 45 mg/m², more preferably from 2 to 20 mg/m², still more preferably from 3 to 8 mg/m². If the amount used is less than this range, the antifouling performance may not be sufficiently brought out, whereas if it exceeds the above-described range, non-uniformity is generated in the surface composition and the light-diffusing film of the present invention becomes unsuitable particularly as a protective film of an image display device. The coated amount of the silicone resin can be adjusted to fall within the above-described range by controlling the amount of the active energy ray-curable silicone resin used in the curable composition for forming the light-diffusing layer, according to the film thickness of the light-diffusing layer provided.

The content of the active energy ray-curable silicone resin in the curable composition of the present invention is preferably from 0.001 to 0.5 mass %, more preferably from 0.001 to 0.2 mass %, further preferably from 0.005 to 0.1 mass %, and most preferably from 0.01 to 0.05 mass %, based on all active energy ray-curable resins used in the curable composition.

The fluorine-based compound is preferably a compound having a fluoroalkyl group. The fluoroalkyl group preferably has a carbon number of 1 to 20, more preferably from 1 to 10, and may have a linear chain (e.g., —CF₂CF₃, —CH₂(CF₂)₄H, —CH₂(CF₂)₈CF₃, —CH₂CH₂(CF₂)₄H), a branched structure (e.g., —CH(CF₃)₂, —CH₂CF(CF₃)₂, —CH(CH₃) CF₂CF₃, —CH(CH₃)(CF₂)₅CF₂H) or an alicyclic structure (preferably a 5-membered or 6-membered ring, for example, a perfluorocyclohexyl group, a perflurocyclopentyl group or an alkyl group substituted by such a group) or may have an ether bond (e.g., —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H). A plurality of fluoroalkyl groups may be contained in the same molecule.

The fluorine-based compound preferably further has a substituent contributing to the bond formation or compatibility with the light-diffusing layer film. A plurality of substituents, which may be the same or different, are preferably present. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group and an amino group. The fluorine-based compound may be a polymer or oligomer with a compound not containing a fluorine atom and is used without any particular limitation in the molecular weight. The fluorine atom content of the fluorine-based compound is not particularly limited but is preferably 20 mass % or more, more preferably from 30 to 70 mass %, and most preferably from 40 to 70 mass %. Preferred examples of the fluorine-based compound include, but are not limited to, R-2020, M-2020, R-3833 and M-3833 (all trade names) produced by Daikin Industries, Ltd.; and Megafac F-171, F-172 and F-179A and DYFENSA MCF-300 (all trade names) produced by Dai-Nippon Ink & Chemicals, Inc.

In the present invention, the active energy ray-curable silicone resin and the fluorine-containing compound may be used in combination.

In the present invention, it is effective to unevenly distribute an antifouling compound, that is, the above-described silicone resin and fluorine-containing compound, to the surface of the light-diffusing layer. The uneven distribution is measured quantitatively by the following methods.

The method for measuring the segregation of a silicone or fluoroalkyl group on the surface of the light-diffusing layer is described below. Each light-diffusing film is measured by ESCA-3400 (degree of vacuum: 1×10⁻⁵ Pa, X-ray source, target: Mg, voltage: 12 kV, current: 20 mA) to determine the photoelectron spectral intensity ratios Si2p/C1s (=Si(a)) and F1s/C1s (=F(a)) of Si2p, F1s and C1s on the outermost surface, and a lower layer revealed after shaving the light-diffusing layer to the depth of 100 nm from the surface by an ion etching apparatus (ion gun, voltage: 2 kV, current: 20 mA) attached to ESCA-3400 is measured to determine the photoelectron spectral intensity ratios Si2p/C1s (=Si(b)) and F1s/C1s (=F (b)). From these measured values, the change in each intensity ratio between before and after etching, that is, Si(a)/Si(b) or F(a)/F(b), is determined. Based on the change between before and after etching (photoelectron spectral intensity ratio in the outermost part of the low refractive index layer/the photoelectron spectral intensity ratio near the lower layer in the depth of 100 nm from the surface of the low refractive index layer) with respect to each of the ratios Si2p/C1s and F1s/C1s, the degree of surface segregation can be determined.

Incidentally, in the case of containing inorganic silica in the light-diffusing layer, the intensity for F1s and C1s is determined at the peak position of each photoelectron spectrum, and the intensity used for Si2p in the above-described calculation of intensity ratio is determined at the peak position (in the vicinity of a bonding energy of 105 eV) attributable to the Si atom of silicone (polydimethylsiloxane) and can be differentiated from the Si atom originated in the inorganic silica particle.

A preliminary test of gradually shaving down the light-diffusing layer surface under various etching conditions is previously performed and based on the etching conditions required to arrive at the 100 nm, 200 nm or 300 nm lower layer, the conditions to reach the depth of 100 nm from the surface are determined. Thereafter, the intensity ratios are measured. In the case of controlling only the surface property, only a necessary component can be selectively disposed on the surface by appropriately using the surface segregating compound described in the present invention, and the internal property and the surface property of the film can be independently controlled.

The photoelectron spectral intensity ratio Si/C and/or F/C in the surface ESCA (X-ray electron spectroscopy for chemical analysis) of the light-diffusing film is preferably 0.6 or more.

Also, it is preferred that the fluorine atom and/or silicon atom segregates on the surface of the light-diffusing film and in the ESCA (X-ray electron spectroscopy for chemical analysis) of the outermost surface and a layer 100 nm lower than the outermost surface, the photoelectron spectral intensity ratio Si/C and/or F/C on the outermost surface is as large as 5 times or more that in the 100 nm lower layer.

[Impartation of Pencil Hardness]

The light-diffusing film of the present invention needs to continuously maintain the antifouling property and at the same time, have a surface with high pencil hardness. Therefore, the pencil hardness on the surface of the light-diffusing layer is preferably 3H or more, more preferably 4H or more, still more preferably 5H or more.

The pencil hardness is determined by using a pencil for test prescribed in JIS-S-6006 according to the pencil hardness evaluation method prescribed in JIS-K-5400 and examining the pencil hardness which causes no scratching under a load of 4.9N.

The technical content for increasing the pencil hardness includes, for example, the thickness of light-diffusing layer, the constituent binder, the filler filled and the curing conditions, and these are described later.

<Light-Diffusing Particle>

The average particle diameter of the light-diffusing particle for use in the light-diffusing film of the present invention is 1.0 μm or more and preferably 15.0 μm or less. The average particle diameter is preferably from 3.0 to 12.0 μm, more preferably from 5.0 to 10.0 μm. If the average particle diameter is less than 1 μm, the scattering angle distribution of light expands to a wide angle and this disadvantageously brings about letter blurring of the display, whereas if it exceeds 15 μm, the film thickness of the light-diffusing layer must be increased and there arises a problem such as large curling or rising of the material cost.

According to the studies by the present inventors, it has been found that increase in the thickness is effective for improving the pencil hardness and when a relatively large-size light-diffusing particle having an average particle diameter of 5 μm or more is combined with an average film thickness of 8 μm or more of the light-diffusing layer, both the pencil hardness and the optical property can be satisfied.

If the thickness of a light-diffusing film having good optical property is excessively increased, the internal haze increasing in proportion to the film thickness exceeds the applicable range. The internal haze may be adjusted by decreasing the amount of the light-diffusing particle added, but the light-diffusing particle contained in the light-diffusing layer also has a role of releasing the cure shrinkage and when the amount added thereof is decreased, the film becomes brittle. It has been found that by increasing the particle size, the surface area can be made small with the same amount added and the haze can be decreased.

Also, by increasing the size, the scattering angle of light can be narrowed and this is generally preferred.

Specific preferred examples of the light-diffusing particle include a resin particle (preferably a resin bead) such as poly((meth)acrylate) particle, crosslinked poly((meth)acrylate) particle, polystyrene particle, crosslinked polystyrene particle, crosslinked poly(acryl-styrene) particle, melamine resin particle and benzoguanamine resin particle. Among these, a crosslinked polystyrene particle, a crosslinked poly((meth)acrylate) particle and a crosslinked poly(acryl-styrene) particle are more preferred. By adjusting the refractive index of the curable resin in accordance with the refractive index of the light-diffusing particle selected from these particles, the internal haze, surface haze and centerline average roughness each can be controlled to the preferred range. More specifically, a combination of a curable resin (refractive index after curing: from 1.50 to 1.53) mainly comprising a trifunctional or greater functional (meth)acrylate monomer which is described later and preferably used for the light-diffusing layer of the present invention, with a light-diffusing particle comprising a crosslinked poly(meth)acrylate polymer having an acryl content of 50 to 100 mass % is preferred, and a combination of the above-described curable resin with a light-diffusing particle (refractive index: from 1.48 to 1.54) comprising a crosslinked poly(styrene-acryl) copolymer is more preferred.

The particle diameter distribution of the light-diffusing particle is preferably narrower. The S value indicating the particle diameter distribution of the particle, which is represented by the following formula, is preferably 2.0 or less, more preferably 1.0 or less, still more preferably 0.7 or less.
S=[D(0.9)−D(0.1)]/D(0.5)

D(0.1): a 10% value of the integration value of the volumetric particle diameter, D(0.5): a 50% value of the integration value of the volumetric particle diameter, and D(0.9): a 90% value of the integration value of the volumetric particle diameter.

Also, two or more kinds of light-diffusing particles differing in the particle diameter may be used in combination. A light-diffusing particle having a larger particle diameter can impart the antiglare property, and a light-diffusing particle having a smaller particle diameter can reduce the surface glaring.

The light-diffusing particle is blended so that the formed light-diffusing layer can have 3 to 35 parts by mass of a light-diffusing particle per 100 parts by mass in the total solid content of the light-diffusing layer. The light-diffusing particle content is preferably from 3 to 30 parts by mass, more preferably from 5 to 20 parts by mass. If the light-diffusing particle content is less than 3 parts by mass, the light diffusibility is insufficient, whereas if it exceeds 35 parts by mass, there arises a problem such as image blurring or surface clouding or glaring.

The coating amount of the light-diffusing particle is preferably from 10 to 1,000 mg/m², more preferably from 100 to 700 mg/m².

The refractive index of the curable resin and light-diffusing particle for use in the present invention is preferably from 1.45 to 1.70, more preferably from 1.48 to 1.65. The refractive index in this range can be obtained by appropriately selecting the kind and amount ratio of the curable resin and light-diffusing particle. How to select these can be easily known in advance by an experiment.

Also, in the present invention, the difference in the refractive index between the curable resin and the light-diffusing particle (refractive index of light-diffusing particle—refractive index of curable resin) is preferably, in terms of the absolute value, from 0.001 to 0.030, more preferably from 0.001 to 0.020, still more preferably from 0.001 to 0.015. If this difference exceeds 0.030, there arises a problem such as film letter burring, reduction in the dark room contrast, or surface clouding.

Here, the refractive index of the curable resin may be quantitatively evaluated by directly measuring the refractive index with an Abbe refractometer or by measuring a spectral reflection spectrum or a spectral ellipsometry. The refractive index of the light-diffusing particle is determined as follows. The light-diffusing particle is dispersed in an equal amount in solvents prepared by changing the mixing ratio of two kinds of solvents differing in the refractive index and thereby varying the refractive index, the turbidity is measured, and the refractive index of the solvent when the turbidity becomes minimum is measured by an Abbe refractometer.

The thickness of the light-diffusing layer is preferably from 1 to 50 μm, more preferably from 8 to 40 μm, still more preferably from 12 to 35 μm, yet still more preferably from 20 to 30 μm. If the thickness is too small, the hardcoat property is insufficient, whereas if the thickness is excessively large, bad curling or brittleness may result to deteriorate the processing suitability. Accordingly, the thickness is preferably in the above-described range.

The centerline average surface roughness (Ra) of the optical film of the present invention is preferably from 0.025 to 0.50 μm, more preferably from 0.04 to 0.30 μm, and most preferably from 0.05 to 0.25 μm. Within this range, an appropriate scattering performance can be obtained without causing any problem such as white blurring. The fluorine-based or polydimethylsiloxane-based compound used for adjusting the contact angle with water to 90° or more is readily transferred to the back surface during storage of the optical film in the rolled state and when the compound transferred aggregates, adhesion failure or the like may occur at the bonding to the display surface. In the present invention, the centerline average surface roughness (Ra) is 0.025 or more and this advantageously provides an effect of reducing the transfer to the back surface.

<Curable Resin>

The curable resin is preferably a binder polymer having a saturated hydrocarbon chain or a polyether chain as the main chain, more preferably a binder polymer having a saturated hydrocarbon chain as the main chain. Also, the binder polymer preferably has a crosslinked structure.

The binder polymer having a saturated hydrocarbon chain as the main chain is preferably a polymer of an ethylenically unsaturated monomer. The binder polymer having a saturated hydrocarbon chain as the main chain and having a crosslinked structure is preferably obtained by using a (co)polymer of a monomer having two or more ethylenically unsaturated groups.

In order to more elevate the refractive index of the binder polymer, there may also be selected, for example, a high refractive index monomer obtained by incorporating an aromatic ring or at least one atom selected from a halogen atom (except for fluorine), a sulfur atom, a phosphorus atom and a nitrogen atom into the structure of the above-described monomer, or a monomer having a fluorene skeleton within the molecule.

Examples of the monomer having two or more ethylenically unsaturated groups include an ester of a polyhydric alcohol and a (meth)acrylic acid [e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate], an ethylene oxide-modified or caprolactone-modified product of such an ester, a vinylbenzene and a derivative thereof [e.g., 1,4-divinylbenzene, 2-acryloylethyl 4-vinylbenzoate, 1,4-divinylcyclohexanone], a vinylsulfone (e.g., divinylsulfone), an acrylamide (e.g., methylenebisacrylamide), and a methacrylamide.

A compound where two or more ethylenically unsaturated groups are introduced into one molecule through a urethane bond or an isocyanuric acid ethoxy-modified diacrylate is preferably used to attain improved antifouling durability. Examples thereof include a polymerizable vinyl group-containing vinylurethane compound (see, for example, JP-B-48-41708 (the term “JP-B” as used herein means an “examined Japanese patent publication”)), urethane acrylates (see, for example, JP-B-2-16765 and JP-A-2005-272702 (e.g., compounds PETA-IPDI-PETA, PETA-TDI-PETA, HEA-IPDI-HEA and U-15HA)), and a urethane compound having an ethylene oxide-based skeleton (see, for example, JP-B-62-39418).

For the reduction of curling, an isocyanuric acid ethoxy-modified diacrylate (described in JP-A-2005-103973) compound shown below is also preferred.

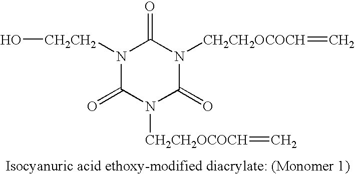

When this compound is used in combination with a trifunctional or higher acrylate, a coating film with low curling and excellent scratch resistance can be formed.

Two or more species of these monomers may be used in combination.

Specific examples of the high refractive index monomer include (meth)acrylates having a fluorene skeleton, bis(4-methacryloylthiophenyl) sulfide, vinylnaphthalene, vinylphenyl sulfide and 4-methacryloxyphenyl-4′-methoxyphenyl thioether. Two or more species of these monomers may also be used in combination.

The polymerization of such an ethylenically unsaturated group-containing monomer can be performed by the ionizing radiation irradiation or heating in the presence of a photoradical initiator or a thermal radical initiator.

Accordingly, the light-diffusing layer can be formed by preparing a coating solution containing a monomer for the formation of a curable resin, such as ethylenically unsaturated monomer described above, a photoradical or thermal radical initiator, a light-diffusing particle and a compound for increasing the contact angle with water on the light-diffusing layer surface and, if desired, further containing an inorganic filler and a leveling agent, which are described later, applying the coating solution onto a transparent substrate, and curing the coating film through a polymerization reaction by the effect of ionizing radiation or heat.

Examples of the photoradical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes and coumarins.

Examples of the acetophenones include 2,2-dimethoxyacetophenone, 2,2-diethoxyacetophenone, p-dimethylacetophenone, 1-hydroxydimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)butanone, 4-phenoxydichloroacetophenone and 4-tert-butyl-dichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone) and 3,3′,4,4′-tetra(tert-butylperoxy-carbonyl)benzophenone.

Examples of the phosphine oxides include 2,4,6-trimethylbenzoyldiphenylphosphine oxide.

Examples of the active esters include IRGACURE OXE01 (1,2-octanedione, 1-[4-(phenylthio)-2-(O-benzoyloxime)], produced by Ciba Specialty Chemicals) sulfonic acid esters and cyclic active ester compounds.

Examples of the onium salts include an aromatic diazonium salt, an aromatic iodonium salt and an aromatic sulfonium salt.

Examples of the borate salt include ion complexes with a cationic coloring matter.

As for the active halogens, an S-triazine or oxathiazole compound is known, and examples thereof include 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)amino)phenyl)-4,6-bis(trichloromethyl)-s-triazine and 2-trihalomethyl-5-(p-methoxyphenyl)-1,3,4-oxadiazole.

Examples of the inorganic complex include bis(η⁵-2,4-cyclopentadien-1-yl)-bis(2,6-difluoro-3-(1H-pyrrol-1-yl)-phenyl)titanium.

Examples of the coumarins include 3-ketocoumarin.

One of these initiators may be used alone, or some species thereof may be used as a mixture.

In the present invention, particularly when the light-diffusing layer is formed to a large thickness of 8 μm or more, a photopolymerization initiator having absorption in the long wave region and a photopolymerization initiator having no absorption in the long wave range are preferably used in combination. By virtue of using two or more initiators differing in the absorption, from the surface to the inside of the light-diffusing layer can be cured and the pencil hardness or SW scratch resistance can be enhanced. The term “photopolymerization initiator having absorption in the long wave region” as used herein means that when dissolved in acetonitrile to a concentration of 0.1 mass %, the absorbance at 360 nm with use of a 1-cm cell is 0.2 or more. Specifically, examples of the commercial product therefor include Irgacure 369 (5 or more), Irgacure 819 (2.0), Irgacure 907 (0.5) and Irgacure 1700 (0.4) (all produced by Ciba Specialty Chemicals)

Also, various examples are described in Saishin UV Koka Gijutsu (Latest UV Curing Technology), page 159, Gijutsu Joho Kyokai (1991), and these are useful in the present invention.

Preferred examples of the commercially available photoradical polymerization initiator of photo-cleavage type include Irgacure (e.g., 651, 184, 819, 907, 1870 (a 7/3 mixed initiator of CGI-403/Irg 184), 500, 369, 1173, 2959, 4265, 4263) and OXE01 produced by Ciba Specialty Chemicals; KAYACURE (e.g., DETX-S, BP-100, BDMK, CTX, BMS, 2-EAQ, ABQ, CPTX, EPD, ITX, QTX, BTC, MCA) produced by Nippon Kayaku Co., Ltd.; and Esacure (e.g., KIP100F, KB1, EB3, BP, X33, KT046, KT37, KIP150, TZT) produced by Sartomer Company, Inc.

In the present invention, the photopolymerization initiator particularly effective for enhancing the antifouling property includes a photopolymerization initiator having interfacial activity, which is described blow. The compound for improving the antifouling property used in the present invention is mostly present in the vicinity of the light-diffusing layer surface and therefore, when a photopolymerization initiator is caused to be selectively present in that region, the curing of the surface can be promoted and the compound for improving the antifouling property can be effectively fixed.

The photopolymerization initiator having interfacial activity is a photopolymerization initiator having a surface-orientation functional group within the molecule. Examples of the surface-orientation functional group include a long-chain alkyl group, a (poly)dialkylsiloxane unit-containing group, a fluoroalkyl group and a fluoroaryl group. Among these, a long-chain alkyl group and a (poly) dialkylsiloxane unit-containing group are preferred.

Specifically, the compounds described in JP-T-2004-522819 (the term “JP-T” as used herein means a “published Japanese translation of a PCT patent application”) may be used, and the compounds of Examples 1 to 14 are preferred.

The photopolymerization initiator is preferably used in an amount of 0.1 to 15 parts by mass, more preferably from 1 to 10 parts by mass, per 100 parts by mass of the polyfunctional monomer.

In addition to the photopolymerization initiator, a photosensitizer may be used. Specific examples of the photosensitizer include n-butylamine, triethylamine, tri-n-butylphosphine, Michler's ketone and thioxanthone.

Furthermore, one or more auxiliary such as azide compound, thiourea compound and mercapto compound may be used in combination.

Examples of the commercially available photosensitizer include KAYACURE (e.g., DMBI, EPA) produced by Nippon Kayaku Co., Ltd.

As for the thermal radical initiator, an organic or inorganic peroxide, an organic azo or diazo compound, or the like may be used.

Specific examples of the organic peroxide include benzoyl peroxide, halogen benzoyl peroxide, lauroyl peroxide, acetyl peroxide, dibutyl peroxide, cumene hydroperoxide and butyl hydroperoxide; specific examples of the inorganic peroxide include hydrogen peroxide, ammonium persulfate and potassium persulfate; specific examples of the azo compound include 2,2′-azobis(isobutyronitrile), 2,2′-azobis(propionitrile) and 1,1′-azobis(cyclohexanecarbonitrile); and specific examples of the diazo compound include diazoaminobenzene and p-nitrobenzenediazonium.

The polymer having a polyether as the main chain is preferably a ring-opened polymer of a polyfunctional epoxy compound. The ring-opening polymerization of the polyfunctional epoxy compound may be performed by the ionizing radiation irradiation or heating in the presence of a photoacid generator or a thermal acid generator.

Accordingly, the light-diffusing layer can be formed by preparing a coating solution containing a polyfunctional epoxy compound, a photoacid generator or thermal acid generator, a light-diffusing particle and a compound for increasing the contact angle with water on the light-diffusing layer surface and, if desired, further containing a leveling agent and an inorganic filler, which are described later, applying the coating solution on a transparent substrate, and curing the coating film through a polymerization reaction by the effect of active energy rays or heat.

A crosslinked structure may be introduced into the binder polymer by using a crosslinking functional group-containing monomer in place of or in addition to the monomer having two or more ethylenically unsaturated groups, thereby introducing a crosslinking functional group into the polymer, and bringing about a reaction of the crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. In addition, a vinylsulfonic acid, an acid anhydride, a cyanoacrylate derivative, a melamine, an etherified methylol, an ester, a urethane and a metal alkoxide (e.g., tetramethoxysilane) may also be utilized as the monomer for introducing a crosslinked structure. A functional group which exhibits crosslinking property as a result of decomposition reaction, such as block isocyanate group, may also be used. That is, in the present invention, the crosslinking functional group may be a functional group which exhibits reactivity not directly but as a result of decomposition.

The binder polymer having such a crosslinking functional group can form a crosslinked structure through heating after coating.

[Inorganic Oxide Fine Particle]

The inorganic oxide fine particle which can be used in the present invention is described below.

In view of colorlessness of the cured film obtained from the curable composition, the inorganic oxide fine particle is preferably an oxide particle of at least one element selected from the group consisting of silicon, aluminum, zirconium, titanium, zinc, germanium, indium, tin, antimony and cerium.

This inorganic fine particle is introduced for the purpose of, for example, elevating the refractive index, preventing the crosslinking shrinkage or increasing the strength of the light-diffusing layer, and is preferably dispersed uniformly in the thickness direction of the cured film.

Examples of the inorganic oxide particle include particles of silica, alumina, zirconia, titanium oxide, zinc oxide, germanium oxide, indium oxide, tin oxide, indium-tin oxide (ITO), antimony oxide and cerium oxide. Among these, particles of silica, alumina, zirconia and antimony oxide are preferred in the light of high hardness. One of these inorganic oxide particles may be used alone, or two or more species thereof may be used in combination. Furthermore, the inorganic oxide particle is preferably used in the form of an organic solvent dispersion. In the case of an organic solvent dispersion, the dispersion medium is preferably an organic solvent in view of compatibility with other components and dispersibility. Examples of such an organic solvent include alcohols such as methanol, ethanol, isopropanol, butanol and octanol; ketones such as acetone, methyl ethyl ketone, methyl isobutyl ketone and cyclohexanone; esters such as ethyl acetate, butyl acetate, ethyl lactate, γ-butyrolactone, propylene glycol monomethyl ether acetate and propylene glycol monoethyl ether acetate; ethers such as ethylene glycol monomethyl ether and diethylene glycol monobutyl ether; aromatic hydrocarbons such as benzene, toluene and xylene; and amides such as dimethylformamide, dimethylacetamide and N-methylpyrrolidone. Among these, preferred are methanol, isopropanol, butanol, methyl ethyl ketone, methyl isobutyl ketone, ethyl acetate, butyl acetate, toluene and xylene.

The number average particle diameter of the oxide particle is preferably from 1 to 2,000 nm, more preferably from 3 to 200 nm, still more preferably from 5 to 100 nm. If the number average particle diameter exceeds 2,000 μm, a cured product reduced in the transparency or a coat having a deteriorated surface state tends to result. In order to improve the dispersibility of particles, various surfactants or amines may also be added.

With respect to the commercial product available as a liquid dispersion of silicon oxide particle (e.g., silica particle), examples of the colloidal silica include Methanol Silica Sol, MA-ST-MS, IPA-ST, IPA-ST-MS, IPA-ST-L, IPA-ST-ZL, IPA-ST-UP, EG-ST, NPC-ST-30, MEK-ST, MEK-ST-L, MIBK-ST, NBA-ST, XBA-ST, DMAC-ST, ST-UP, ST-OUP, ST-20, ST-40, ST-C, ST-N, ST-O, ST-50 and ST-OL produced by Nissan Chemical Industries, Ltd.; and examples of the hollow silica include CS60-IPA produced by Catalysts & Chemicals Industries Co., Ltd. As for the powder silica, examples thereof include Aerosil 130, Aerosil 300, Aerosil 380, Aerosil TT600 and Aerosil OX50 produced by Nippon Aerosil Co., Ltd.; Sildex H31, H32, H51, H52, H121 and H122 produced by Asahi Glass Co., Ltd.; E220A and E220 produced by Nippon Silica Kogyo K.K.; SYLYSIA 470 produced by Fuji Silysia Chemical Ltd.; and SG Flake produced by Nippon Sheet Glass Co., Ltd.

Examples of the water dispersion of alumina include Alumina Sol-100, Alumina Sol-200 and Alumina Sol-520 produced by Nissan Chemical Industries, Ltd.; examples of the isopropanol dispersion of alumina include AS-150I produced by Sumitomo Osaka Cement Co., Ltd.; examples of the toluene dispersion of alumina include AS-150T produced by Sumitomo Osaka Cement Co., Ltd.; examples of the toluene dispersion of zirconia include HXU-110JC produced by Sumitomo Osaka Cement Co., Ltd.; examples of the water dispersion of zinc antimonate powder include Celnax produced by Nissan Chemical Industries, Ltd.; examples of the powder or solvent dispersion of alumina, titanium oxide, tin oxide, indium oxide, zinc oxide and the like include NanoTek produced by C.I. Kasei Co., Ltd.; examples of the water dispersion sol of antimony-doped tin oxide include SN-100D produced by Ishihara Sangyo Kaisha, Ltd.; examples of the ITO powder include products of Mitsubishi Materials Corp.; and examples of the water dispersion of cerium oxide include Needral produced by Taki Chemical Co., Ltd.

The shape of the oxide particle is spherical, hollow, porous, rod-like, plate-like, fibrous or amorphous, preferably spherical. The specific surface area of the oxide particle (as measured by the BET specific surface area measuring method using nitrogen) is preferably from 10 to 1,000 m²/g, more preferably from 20 to 500 m²/g, and most preferably from 50 to 300 m²/g. This inorganic oxide particle may be used by dispersing its powder in the dry state in an organic solvent but, for example, a liquid dispersion of fine particulate oxide particle, known in the art as a solvent dispersion sol of the above-described oxide, can be used directly.

[Dispersion Method]

In the present invention, for preparing the inorganic oxide fine particle by dispersing its powder form in a solvent, a dispersant may be used. Use of a dispersant having an anionic group is preferred in the present invention.

As for the anionic group, a group having an acidic proton, such as carboxyl group, sulfonic acid group (sulfo), phosphoric acid group (phosphono) and sulfonamide group, or a salt thereof is effective. In particular, a carboxyl group, a sulfonic acid group, a phosphoric acid group and a salt thereof are preferred, and a carboxyl group and a phosphoric acid group are preferred. For the purpose of more improving the dispersibility, a plurality of anionic groups may be contained. The average number of anionic groups is preferably 2 or more, more preferably 5 or more, still more preferably 10 or more. Also, plural kinds of anionic groups may be contained in one molecule of the dispersant.

The dispersant may further contain a crosslinking or polymerizable functional group. Examples of the crosslinking or polymerizable functional group include an ethylenically unsaturated group (e.g., (meth)acryloyl, allyl, styryl, vinyloxy) capable of undergoing addition reaction/polymerization reaction by the effect of a radical species; a cationic polymerizable group (e.g., epoxy, oxatanyl, vinyloxy); and a polycondensation reactive group (e.g., hydrolyzable silyl, N-methylol). Among these, a functional group having an ethylenically unsaturated group is preferred.

In the present invention, a disperser may be used for pulverizing the inorganic oxide particle. Examples of the disperser include a sand grinder mill (e.g., bead mill with pin), a high-speed impeller, a pebble mill, a roller mill, an attritor and a colloid mill. Among these, a sand grinder mill and a high-speed impeller are preferred. Also, a preliminary dispersion treatment may be performed. Examples of the disperser for use in the preliminary dispersion treatment include a ball mill, a three-roll mill, a kneader and an extruder.

[High Refractive Index Inorganic Fine Particle]

For elevating the refractive index of the light-diffusing layer, the layer preferably contains, in addition to the above-described light-diffusing particle, an inorganic fine particle comprising an oxide of at least one metal selected from the group consisting of titanium, zirconium, aluminum, indium, zinc, tin and antimony, and having an average particle diameter of 0.001 to 0.2 μm, preferably from 0.001 to 0.1 μm, more preferably from 0.001 to 0.06 μm. Specific examples of the inorganic fine particle for use in the hardcoat layer include TiO₂, ZrO₂, Al₂O₃, In₂O₃, ZnO, SnO₂, Sb₂O₃ and tin-doped indium oxide (ITO). Among these, TiO₂ and ZrO₂ are preferred from the standpoint of elevating the refractive index. It is also preferred that the surface of the inorganic fine particle is subjected to a silane coupling treatment or a titanium coupling treatment. A surface treating agent having a functional group capable of reacting with the binder species on the filler surface is preferably used.

The amount of the inorganic fine particle added is preferably from 10 to 90 mass %, more preferably from 20 to 80 mass %, still more preferably from 30 to 75 mass %, based on the entire mass of the light-diffusing layer.

Incidentally, such an inorganic fine particle has a particle diameter sufficiently smaller than the wavelength of light and therefore, causes no scattering, and the dispersion obtained by dispersing the filler in the binder polymer behaves as an optically uniform substance.

The mixture of the binder and the inorganic fine particle in the light-diffusing layer preferably has a refractive index of 1.57 to 2.00, more preferably from 1.60 to 1.80. The refractive index in this range can be obtained by appropriately selecting the kind and amount ratio of the binder and inorganic fine particle. How to select these can be easily known in advance by an experiment.

[Solvent of Coating Solution]

An organic solvent dispersion of the above-described inorganic oxide fine particle according to the present invention is used and combined as a fine particle component with a binder to prepare a coating composition, and a light-diffusing layer can be formed from this composition. The solvent of the coating composition is not limited, but at least two kinds of volatile solvents are preferably used. For example, at least two members selected from alcohols and derivatives thereof, ethers, ketones, hydrocarbons and esters are preferably used in combination. The solvents can be selected by taking account of the solubility of binder component, the stability of inorganic fine particle, the control of viscosity of the coating solution, and the like. By using two or more kinds of solvents in combination, fine particles can be arranged in the film in a controlled manner as specified in the present invention. The boiling point of the solvent for use in the present invention is preferably from 50 to 250° C., more preferably from 65 to 200° C. The dielectric constant at 20° C. is preferably from 1 to 50, more preferably from 5 to 30. When a solvent having a dielectric constant of 10 or more is contained in an amount of 10 mass % or more based on the inorganic fine particle, this is preferred in view of dispersion stability.

Examples of the solvent which can be used in the present invention include, but are not limited to, the followings:

alcohols and derivatives thereof (e.g., methanol, ethanol, n-propanol, isopropyl alcohol, n-butanol, isobutanol, secondary butanol, tertiary butanol, n-amyl alcohol, isoamyl alcohol, secondary amyl alcohol, 3-pentanol, tertiary amyl alcohol, n-hexanol, methyl amyl alcohol, 2-ethyl butanol, n-heptanol, 2-heptanol, 3-heptanol, n-octanol, 2-octanol, 2-ethyl hexanol, 3,5,5-trimethyl hexanol, nonanol, benzyl alcohol, ethylene glycol, ethylene glycol monomethyl ether, ethylene glycol monomethyl ether acetate, ethylene glycol monoethyl ether, ethylene glycol diethyl ether, ethylene glycol monoethyl ether acetate, ethylene glycol isopropyl ether, ethylene glycol monobutyl ether, ethylene glycol dibutyl ether, ethylene glycol monobutyl ether acetate, ethylene glycol isoamyl ether, methoxy-methoxyethanol, methoxypropanol, butoxyethanol, ethylene glycol monoacetate, ethylene glycol diacetate, diethylene glycol, diethylene glycol monomethyl ether, diethylene glycol monoethyl ether, diethylene glycol diethyl ether, propylene glycol, propylene glycol monomethyl ether, propylene glycol monoethyl ether, propylene glycol monobutyl ether, dipropylene glycol monomethyl ether, dipropylene glycol monomethyl ether, dipropylene glycol monoethyl ether);

ethers (e.g., isopropyl ether, n-butyl ether, diisoamyl ether, methyl phenyl ether, ethyl phenyl ether);

ketones (e.g., acetone, methyl acetone, methyl ethyl ketone, methyl-n-propyl ketone, methyl-n-butyl, methyl isobutyl ketone, methyl-n-amyl ketone, methyl-n-hexyl ketone, diethyl ketone, ethyl-n-butyl ketone, di-n-propyl ketone, diisobutyl ketone, acetonylacetone, diacetone alcohol, cyclohexanone, methylcyclohexanone);

hydrocarbons (e.g., n-hexane, isohexane, n-heptane, n-octane, isooctane, n-decane, toluene, xylene, ethylbenzene, diethylbenzene, isopropylbenzene, amylbenzene); and

esters (e.g., propyl formate, n-butyl formate, isobutyl formate, amyl formate, ethyl acetate, n-propyl acetate, isopropyl acetate, n-butyl acetate, isobutyl acetate, secondary butyl acetate, n-amyl acetate, isoamyl acetate, methylisoamyl acetate, methoxybutyl acetate, secondary hexyl acetate, 2-ethylbutyl acetate, 2-ethylhexyl acetate, cyclohexyl acetate, methylcyclohexyl acetate, benzyl acetate, methyl propionate, ethyl propionate, n-butyl propionate, isoamyl propionate, methyl butyrate, ethyl butyrate, n-butyl butyrate, isoamyl butyrate, ethyl oxyisobutyrate, methyl acetoacetate, ethyl acetoacetate, isoamyl isovalerate, methyl lactate, ethyl lactate, n-butyl lactate, isobutyl lactate, n-amyl lactate, isoamyl lactate, methyl benzoate, diethyl oxalate).

A combination of at least two members selected from alcohols and derivatives thereof, ketones and esters is preferred, and a combination of three members selected from these is more preferred. For example, two or three members selected from methyl ethyl ketone, methyl isobutyl ketone, cyclohexanone, 2-methoxypropanol, 2-butoxyethanol, isopropyl alcohol and toluene may be preferably used in combination.

[Transparent Plastic Substrate]

The light-diffusing film of the present invention is produced by forming respective layers including an light-diffusing layer on a transparent plastic substrate (hereinafter sometimes referred to as a “transparent support”)

The light transmittance of the transparent plastic substrate is preferably 80% or more, more preferably 86% or more. The haze of the transparent support is preferably 2.0% or less, more preferably 1.0% or less. The refractive index of the transparent plastic substrate is preferably from 1.4 to 1.7.

Examples of the material for the transparent plastic film include a cellulose ester, a polyamide, a polycarbonate, a polyester (e.g., polyethylene terephthalate, polyethylene naphthalate, poly-1,4-cyclohexanedimethylene terephthalate, polyethylene-1,2-diphenoxyethane-4,4′-dicarboxylate, polybutylene terephthalate), a polystyrene (e.g., syndiotactic polystyrene), a polyolefin (e.g., polypropylene, polyethylene, polymethylpentene), a norbornene-based resin {“ARTON” (trade name), produced by JSR Corp.}, an amorphous polyolefin {“ZEONEX” (trade name), produced by ZEON Corp.}, a polysulfone, a polyethersulfone, a polyarylate, a polyetherimide, a polymethyl methacrylate and a polyether ketone. Among these, a cellulose ester, a polycarbonate, a polyethylene terephthalate and a polyethylene naphthalate are preferred.

[Cellulose Acylate Film]

Particularly, in the case of using the light-diffusing film of the present invention for a liquid crystal display device, a cellulose acylate film is preferred. The cellulose acylate is produced by esterifying a cellulose. As for the cellulose before esterification, linter, kenaf or pulp is purified and used.

(Cellulose Acylate)

The cellulose acylate as used in the present invention means a fatty acid ester of cellulose, and a lower fatty acid ester is preferred. Furthermore, a fatty acid ester film of cellulose is preferred.

The lower fatty acid means a fatty acid having a carbon atom number of 6 or less. A cellulose acylate having a carbon atom number of 2 to 4 is preferred. In particular, a cellulose acetate is preferred. It is also preferred to use a mixed fatty acid ester such as cellulose acetate propionate and cellulose acetate butyrate.

The viscosity average degree of polymerization (Dp) of the cellulose acylate is preferably 250 or more, more preferably 290 or more. Also, the molecular weight distribution of the cellulose acylate, indicated by Mw/Mn (Mw: mass average molecular weight, Mn: number average molecular weight) according to gel permeation chromatography, is preferably narrow. Specifically, the Mw/Mn value is preferably from 1.0 to 5.0, more preferably from 1.0 to 3.0, still more preferably from 1.0 to 2.0.

A cellulose acylate having an acetylation degree of 55.0 to 62.5% is preferably used as the transparent support. The acetylation degree is more preferably from 57.0 to 62.0%, still more preferably 59.0 to 61.5%. The acetylation degree means the amount of acetic acid bonded per unit mass of cellulose. The acetylation degree can be determined according to the measurement and calculation of acetylation degree in ASTM: D-817-91 (Test Method of Cellulose Acetate, etc.).

In the cellulose acylate, the hydroxyl is not equally substituted to the 2-, 3- and 6-positions of cellulose, but the substitution degree at the 6-position tends to be small. In the cellulose acylate for use in present invention, the substitution degree at the 6-position of cellulose is preferably equal to or larger than that at the 2- or 3-position. The proportion of the substitution degree at the 6-position is preferably from 30 to 40%, more preferably from 31 to 40%, and most preferably from 32 to 40%, based on the total of the substitution degrees at the 2-, 3- and 6-positions.

For the purpose of adjusting the properties of the film, such as mechanical property (e.g., film strength, curl, dimensional stability, slipperiness) and durability (e.g., moisture and heat resistance, weather resistance), various additives may be used in the transparent support. Examples of the additive include a plasticizer (e.g., phosphoric acid esters, phthalic acid esters, esters of polyol and fatty acid), an ultraviolet inhibitor (e.g., hydroxybenzophenone-based compound, benzotriazole-based compound, salicylic acid ester-based compound, cyanoacrylate-based compound), a deterioration inhibitor (e.g., antioxidant, peroxide decomposer, radical inhibitor, metal inactivating agent, acid scavenger, amine), a fine particle (e.g., SiO₂, Al₂O₃, TiO₂, BaSO₄, CaCO₃, MgCO₃, talc, kaolin), a release agent, an antistatic agent and an infrared absorbent.

These additives are described in detail in JIII Journal of Technical Disclosure, No. 2001-1745, pp. 17-22, Japan Institute of Invention and Innovation (Mar. 15, 2001), and the materials described therein are preferably used.

The amount of such an additive used is preferably from 0.01 to 20 mass %, more preferably from 0.05 to 10 mass %, based on the transparent support.

[Surface Treatment]

The transparent support may be subjected to a surface treatment.

Examples of the surface treatment include a chemical treatment, a mechanical treatment, a corona discharge treatment, a flame treatment, an ultraviolet irradiation treatment, a high-frequency treatment, a glow discharge treatment, an active plasma treatment, a laser treatment, a mixed acid treatment and an ozone oxidation treatment. These are specifically described, for example, in JIII Journal of Technical Disclosure, No. 2001-1745, pp. 30-31 (Mar. 15, 2001) and JP-A-2001-9973. Among these treatments, a glow discharge treatment, an ultraviolet irradiation treatment, a corona discharge treatment and a flame treatment are preferred, and a glow discharge treatment and an ultraviolet treatment are more preferred.

[Saponification Treatment]

In the case of using the optical film of the present invention for a liquid display device, the optical film is disposed on the outermost surface of the display, for example, by providing a pressure-sensitive adhesive layer on one surface. In the case where the transparent support is triacetyl cellulose, since triacetyl cellulose is used as the protective film for protecting the polarizing layer of a polarizing plate, the optical film of the present invention is preferably used directly as the protective film in view of the cost.

In the case where the optical film of the present invention is disposed on the outermost surface of a display, for example, by providing a pressure-sensitive adhesive layer on one surface or used directly as the protective film of a polarizing plate, in order to ensure satisfactory adhesion, a saponification treatment is preferably performed after an outermost layer mainly comprising a fluorine-containing polymer is formed on a transparent support. The saponification treatment is performed by a known method, for example, by dipping the film in an alkali solution for an appropriate time period. After dipping in an alkali solution, the film is preferably well washed with water or dipped in a dilute acid to neutralize the alkali component and prevent the alkali component from remaining in the film.

By performing a saponification treatment, the surface of the transparent support on the side opposite the surface having the outermost layer is hydrophilized.

The hydrophilized surface is effective particularly for improving the adhesive property to a deflecting film mainly comprising a polyvinyl alcohol. Furthermore, the hydrophilized surface hardly allows for attachment of dust in the air and therefore, dust scarcely intrudes into the space between the deflecting film and the optical film at the bonding to a deflecting film, so that point defects due to dust can be effectively prevented.

The saponification, treatment is preferably performed such that the surface of the transparent support on the side opposite the surface having the outermost layer has a contact angle with water of 40° or less, more preferably 30° or less, still more preferably 20° or less.

The specific method for the alkali saponification treatment can be selected from the following two methods (1) and (2). The method (1) is advantageous in that the treatment can be performed by the same process as that for general-purpose triacetyl cellulose film, but since the antireflection film surface is also saponified, there may arise a problem that the film is deteriorated due to alkali hydrolysis of the surface or the remaining solution for saponification treatment causes staining. In such a case, the method (2) is advantageous, though this is a special process.

(1) After the formation of a surface having an optical function on the transparent support, the support is dipped at least once in an alkali solution, whereby the back surface of the film is saponified.

(2) Before or after the formation of an optical functional layer on the transparent support, an alkali solution is applied to the surface of the optical film on the side opposite the surface where the optical film is formed, and then the support is heated and washed with water and/or neutralized, whereby only the back surface of the film is saponified.

[Coating Film Forming Method]

The light-diffusing film of the present invention can be formed by the following method, but the present invention is not limited to this method.

First, a coating solution containing components for forming each layer is prepared. The coating solution prepared is coated on a transparent support by a dip coating method, an air knife coating method, a curtain coating method, a roller coating method, a wire bar coating method, a gravure coating method or an extrusion coating method (see, U.S. Pat. No. 2,681,294), and then heated and dried. Out of these coating methods, when the coating solution is coated by a gravure coating method, a coating solution for making a dry film thickness of about 8 to 40 μm can be coated with high film thickness uniformity and this is preferred. Among the gravure coating methods, a microgravure coating method is more preferred, because the film thickness uniformity is high.

Furthermore, a coating solution in a small coated amount can be coated with high film thickness uniformity also by a die coating method. The die coating method is a pre-measuring system and therefore, is advantageous in that the control of film thickness is relatively easy and the solvent in the coated part is less transpired. Two or more layers may be coated simultaneously. The simultaneous coating method is described in U.S. Pat. Nos. 2,761,791, 2,941,898, 3,508,947 and 3,526,528, and Yuji Harasaki, Coating Kogaku (Coating Engineering), page 253, Asakura-Shoten (1973).

[Polarizing Plate]

The polarizing plate mainly comprises a polarizing film and two protective films sandwiching the polarizing film from both sides. The optical film of the present invention is preferably used for at least one protective film out of two protective films sandwiching the polarizing film from both sides. By arranging the optical film of the present invention to serve also as a protective film, the production cost of the polarizing plate can be reduced. Furthermore, by using the optical film of the present invention as an outermost surface layer, a polarizing plate prevented from the projection or the like of outside light and excellent in the scratch resistance, antifouling property and the like can be obtained.

As for the polarizing film, a known polarizing film or a polarizing film cut out from a lengthy polarizing film with the absorption axis of the polarizing film being neither parallel nor perpendicular to the longitudinal direction, may be used. The lengthy polarizing film with the absorption axis of the polarizing film being neither parallel nor perpendicular to the longitudinal direction is produced by the following method.

This is a polarizing film obtained through stretching by applying a tension to a continuously fed polymer film while holding both edges of the film with holding means and can be produced according to a stretching method where the film is stretched to 1.1 to 20.0 times at least in the film width direction, the holding devices at both edges of the film are moved to create a difference in the travelling speed of 3% or less in the longitudinal direction, and the film travelling direction is bent, in the state of the film being held at both edges, such that the angle made by the film travelling direction at the outlet in the step of holding both edges of the film and the substantial stretching direction of the film inclines at 20 to 70°. Particularly, a polarizing film produced with an inclination angle of 45° is preferred in view of productivity.

The stretching method of a polymer film is described in detail in JP-A-2002-86554 (paragraphs [0020] to [0030]).

In the case of using the light-diffusing film of the present invention as a surface protective film on one side of the polarizing film, the light-diffusing film can be preferably used for a transmissive, reflective or transflective liquid crystal display device in a mode such as twisted nematic (TN) mode, super-twisted nematic (STN) mode, vertical alignment (VA) mode, in-plane switching (IPS) mode or optically compensated bend cell (OCB) mode.

The VA-mode liquid crystal cell includes (1) a VA-mode liquid crystal cell in a narrow sense where rod-like liquid crystalline molecules are oriented substantially in the vertical alignment at the time of not applying a voltage and oriented substantially in the horizontal alignment at the time of applying a voltage (described in JP-A-2-176625); (2) a (MVA-mode) liquid crystal cell where the VA mode is modified to a multi-domain system for enlarging the viewing angle (described in SID97, Digest of Tech. Papers (preprints), 28, 845 (1997)); (3) a (n-ASM-mode) liquid crystal cell where rod-like liquid crystalline molecules are oriented substantially in the vertical alignment at the time of not applying a voltage and oriented in the twisted multi-domain alignment at the time of applying a voltage (described in preprints of Nippon Ekisho Toronkai (Liquid Crystal Forum of Japan), 58-59 (1998)); and (4) a SURVAIVAL-mode liquid crystal cell (reported in LCD International 98).

For the application to a VA-mode liquid crystal cell, a polarizing plate prepared by combining a biaxially stretched triacetyl cellulose film with the optical film of the present invention is preferably used. As for the production method of a biaxially stretched triacetyl cellulose film, the method described, for example, in JP-A-2001-249223 and JP-A-2003-170492 is preferably used.

The OCB-mode liquid crystal cell is a liquid crystal display device using a liquid crystal cell of bend alignment mode where rod-like liquid crystalline molecules are aligned substantially in opposite directions (symmetrically) at the upper part and the lower part of the liquid crystal cell, and this is disclosed in U.S. Pat. Nos. 4,583,825 and 5,410,422. Since rod-like liquid crystalline molecules are aligned symmetrically between the upper part and the lower part of the liquid crystal cell, the liquid crystal cell of bend alignment mode has a self-optically compensating ability. Accordingly, this liquid crystal mode is also called an OCB (optically compensatory bend) liquid crystal mode. A liquid crystal display device of bend alignment mode is advantageous in that the response speed is fast.

In the ECB-mode liquid crystal cell, rod-like liquid crystalline molecules are oriented substantially in the horizontal alignment at the time of not applying a voltage. This is most popularly used as a color TFT liquid crystal display device and is described in a large number of publications such as EL, PDP, LCD Display, Toray Research Center (2001).

Particularly, in the case of a TN-mode or IPS-mode liquid crystal display device, as described in JP-A-2001-100043 and the like, an optical compensation film having an effect of enlarging the viewing angle is preferably used for the protective film on the side opposite the optical film of the present invention out of front and back two protective films of a polarizing film, because a polarizing plate having an appropriate scattering property and hardcoat property and a viewing angle-enlarging effect with a thickness of one polarizing plate can be obtained.

### EXAMPLES

The present invention is described in greater detail below by referring to Examples, but the present invention is not limited thereto. Unless otherwise indicated, the “parts” and “%” are on the mass basis.

[Preparation of Coating Solution for Light-Diffusing Layer]

{Composition of Coating Solution (HCL-1) for Light-Diffusing Layer}

| | | |
|---|---|---|
| UV-Curable resin: “PETA” {produced by | 600.0 | parts |
| Nippon Kayaku Co., Ltd.} | | |
| “Irgacure 184” | 20.0 | parts |
| Toluene liquid dispersion (30%) of | 17.0 | parts |
| crosslinked polystyrene particle (a 30 wt % | | |
| toluene liquid dispersion of | | |
| SX-350H, average particle diameter: | | |
| 3.5 μm, produced by Soken Kagaku K.K.) | | |
| Toluene liquid dispersion (30%) of | 133.0 | parts |
| crosslinked acryl-styrene particle (a | | |
| 30 wt % toluene liquid dispersion of | | |
| SX-350HL, average particle diameter: | | |
| 3.5 μm, produced by Soken Kagaku K.K.) | | |
| Toluene | 287.0 | parts |
| Cyclohexanone | 98.0 | parts |
| Silicone oil: “X-22-164C” | 0.1 | part |

{Composition of Coating Solution (HCL-2) for Light-Diffusing Layer}

| | | |
|---|---|---|
| UV-Curable resin: “PETA” {produced by | 600.0 | parts |
| Nippon Kayaku Co., Ltd.} | | |
| “Irgacure 184” | 20.0 | parts |
| Toluene liquid dispersion (30%) of | 17.0 | parts |
| crosslinked polystyrene particle (a 30 wt % | | |
| toluene liquid dispersion of | | |
| SX-350H, average particle diameter: | | |
| 3.5 μm, produced by Soken Kagaku K.K.) | | |
| Toluene liquid dispersion (30%) of | 133.0 | parts |
| crosslinked acryl-styrene particle (a | | |
| 30 wt % toluene liquid dispersion of | | |
| SX-350HL, average particle diameter: | | |
| 3.5 μm, produced by Soken Kagaku K.K.) | | |
| Toluene | 287.0 | parts |
| Cyclohexanone | 98.0 | parts |

{Composition of Coating Solution (HCL-3) for Light-Diffusing Layer}

| | | |
|---|---|---|
| UV-Curable resin: “PETA” {produced by | 600.0 | parts |
| Nippon Kayaku Co., Ltd.} | | |
| “Irgacure 184” | 20.0 | parts |
| Toluene liquid dispersion (30%) of | 17.0 | parts |
| crosslinked polystyrene particle (a 30 wt % | | |
| toluene liquid dispersion of | | |
| SX-500H, average particle diameter: | | |
| 5.0 μm, produced by Soken Kagaku K.K.) | | |
| Toluene liquid dispersion (30%) of | 133.0 | parts |
| crosslinked acryl-styrene particle (a | | |
| 30 wt % toluene liquid dispersion of | | |
| crosslinked acryl-styrene particle | | |
| having the same composition as SX-350HL | | |
| and having an average particle diameter | | |
| of 5.0 μm) | | |
| Toluene | 287.0 | parts |
| Cyclohexanone | 98.0 | parts |
| Silicone oil: “X-22-164C” | 0.1 | part |

{Composition of Coating Solution (HCL-4) for Light-Diffusing Layer}

| | | |
|---|---|---|
| UV-Curable resin: “PETA” {produced by | 600.0 | parts |
| Nippon Kayaku Co., Ltd.} | | |
| “Irgacure 184” | 20.0 | parts |
| Toluene liquid dispersion (30%) of | 17.0 | parts |
| crosslinked polystyrene particle (a 30 wt % | | |
| toluene liquid dispersion of | | |
| crosslinked polystyrene particle having | | |
| the same composition as SX-350H and | | |
| having an average particle diameter of | | |
| 7.0 μm) | | |
| Toluene liquid dispersion (30%) of | 133.0 | parts |
| crosslinked acryl-styrene particle (a | | |
| 30 wt % toluene liquid dispersion of | | |
| crosslinked acryl-styrene particle | | |
| having the same composition as SX-350HL | | |
| and having an average particle diameter | | |
| of 7.0 μm) | | |
| Toluene | 287.0 | parts |
| Cyclohexanone | 98.0 | parts |
| Silicone oil: “X-22-164C” | 0.1 | part |

{Composition of Coating Solution (HCL-5) for Light-Diffusing Layer}

| | | |
|---|---|---|
| UV-Curable resin: “PETA” {produced by | 600.0 | parts |
| Nippon Kayaku Co., Ltd.} | | |
| “Irgacure 184” | 20.0 | parts |
| Toluene liquid dispersion (30%) of | 17.0 | parts |
| crosslinked polystyrene particle (a 30 wt % | | |
| toluene liquid dispersion of | | |
| crosslinked polystyrene particle having | | |
| the same composition as SX-350H and | | |
| having an average particle diameter of | | |
| 8.0 μm) | | |
| Toluene liquid dispersion (30%) of | 133.0 | parts |
| crosslinked acryl-styrene particle (a | | |
| 30 wt % toluene liquid dispersion of | | |
| crosslinked acryl-styrene particle | | |
| having the same composition as SX-350HL | | |
| and having an average particle diameter | | |
| of 8.0 μm) | | |
| Toluene | 287.0 | parts |
| Cyclohexanone | 98.0 | parts |
| Silicone oil: “X-22-164C” | 0.1 | part |

{Composition of Coating Solution (HCL-6) for Light-Diffusing Layer}

| | | |
|---|---|---|
| Zirconia fine particle-containing | 612.0 | parts |
| hardcoat composition solution: | | |
| “Desolite Z7404” {particle diameter: | | |
| 20 nm, produced by JSR CORP.} | | |
| UV-Curable resin: “DPHA” {produced by | 234.0 | parts |
| Nippon Kayaku Co., Ltd.} | | |
| Silica particle: “KE-P150” {1.5 μm, | 53.4 | parts |
| produced by Nippon Shokubai Co., Ltd.} | | |
| Crosslinked PMMA particle: “MXS-300” | 20.4 | parts |
| {3 μm, produced by Soken Kagaku K.K.} | | |
| Methyl ethyl ketone (MEK) | 174.0 | parts |
| Cyclohexanone | 78.0 | parts |
| Silicone oil: “X-22-164C” | 0.1 | part |

{Composition of Coating Solution (HCL-7) for Light-Diffusing Layer}

| | | |
|---|---|---|
| Zirconia fine particle-containing | 612.0 | parts |
| hardcoat composition solution: | | |
| “Desolite Z7404” {particle diameter: | | |
| 20 nm, produced by JSR CORP.} | | |
| UV-Curable resin: “DPHA” {produced by | 234.0 | parts |
| Nippon Kayaku Co., Ltd.} | | |
| Silica particle: “KE-P150” {1.5 μm, | 53.4 | parts |
| produced by Nippon Shokubai Co., Ltd.} | | |
| Crosslinked PMMA particle: “MXS-300” | 20.4 | parts |
| {3 μm, produced by Soken Kagaku K.K.} | | |
| Methyl ethyl ketone (MEK) | 174.0 | parts |
| Cyclohexanone | 78.0 | parts |

<Preparation of Light-Diffusing Film>

### Example 1-1

A 1,340 mm-wide and 2,600 m-long triacetyl cellulose film, “TD80U” {produced by Fuji Photo Film Co., Ltd.}, in a roll form was unrolled as the support (substrate), and Coating Solution (HCL-1) for Light-Diffusing Layer, in which the silicone oil having a polymerizable group was added, was coated directly thereon by using a doctor blade and a 50 mm-diameter microgravure roll having a gravure pattern with a line number of 135 lines/inch and a depth of 60 μm, under the condition of a transportation speed of 15 m/min and after drying at 60° C. for 150 seconds, irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) while purging the system with nitrogen to keep an oxygen concentration of 1.0 vol % or less, thereby curing the coated layer and forming Light-Diffusing Layer (HC-1). The resulting film was taken up. After the curing, the rotation number of the gravure roll was adjusted so that the light-diffusing layer could have an average thickness of 6.0 μm.

### Comparative Example 1-1

In the preparation of the light-diffusing film of Example 1-1, Coating Solution (HCL-2) for Light-Diffusing Layer was used in place of Coating Solution (HCL-1) for Light-Diffusing Layer to form Light-Diffusing Layer (HC-2), followed by taking up the resulting film.

### Example 1-2

In the preparation of the light-diffusing film of Example 1-1, Coating Solution (HCL-3) for Light-Diffusing Layer was used in place of Coating Solution (HCL-1) for Light-Diffusing Layer to form Light-Diffusing Layer (HC-3), followed by taking up the resulting film. After the curing, the rotation number of the gravure roll was adjusted so that the light-diffusing layer could have an average thickness of 10.0 μm.

### Example 1-3

In the preparation of the light-diffusing film of Example 1-1, Coating Solution (HCL-4) for Light-Diffusing Layer was used in place of Coating Solution (HCL-1) for Light-Diffusing Layer to form Light-Diffusing Layer (HC-4), followed by taking up the resulting film. After the curing, the rotation number of the gravure roll was adjusted so that the light-diffusing layer could have an average thickness of 20 μm.

### Example 1-4

In the preparation of the light-diffusing film of Example 1-3, after the curing, the rotation number of the gravure roll was adjusted so that the light-diffusing layer could have an average thickness of 24 μm.

### Example 1-5

In the preparation of the light-diffusing film of Example 1-1, Coating Solution (HCL-5) for Light-Diffusing Layer was used in place of Coating Solution (HCL-1) for Light-Diffusing Layer to form Light-Diffusing Layer (HC-5), followed by taking up the resulting film. After the curing, the rotation number of the gravure roll was adjusted so that the light-diffusing layer could have an average thickness of 24 μn.

### Example 2-1

A 1,340 mm-wide and 2,600 m-long triacetyl cellulose film, “TD80U” {produced by Fuji Photo Film Co., Ltd.}, in a roll form was unrolled as the support, and Coating Solution (HCL-6) for Light-Diffusing Layer, in which the silicone oil having a polymerizable group was added, was coated directly thereon by using a doctor blade and a 50 mm-diameter microgravure roll having a gravure pattern with a line number of 135 lines/inch and a depth of 60 μm, under the condition of a transportation speed of 15 m/min and after drying at 60° C. for 150 seconds, irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) while purging the system with nitrogen to keep an oxygen concentration of 1.0 vol % or less, thereby curing the coated layer and forming Light-Diffusing Layer (HC-6). The resulting film was taken up. After the curing, the rotation number of the gravure roll was adjusted so that the light-diffusing layer could have an average thickness of 8.0 μm.

### Comparative Example 2-1

In the preparation of the light-diffusing film of Example 2-1, Coating Solution (HCL-7) for Light-Diffusing Layer was used in place of Coating Solution (HCL-6) for Light-Diffusing Layer to form Light-Diffusing Layer (HC-7), followed by taking up the resulting film.

TABLE 1

| | | Coating Solution | Average | Size of Light- |
|---|---|---|---|---|
| | Sample | for Light- | Film | Diffusing |
| | No. | Diffusing Layer | Thickness | Particle |
| Example 1-1 | 101 | HCL-1 | 6 μm | 3.5 μm |
| Comparative | 102 | HCL-2 | 6 μm | 3.5 μm |
| Example 1-1 | | | | |
| Example 1-2 | 103 | HCL-3 | 10 μm | 5.0 μm |
| Example 1-3 | 104 | HCL-4 | 20 μm | 7.0 μm |
| Example 1-4 | 105 | HCL-4 | 24 μm | 7.0 μm |
| Example 1-5 | 106 | HCL-5 | 24 μm | 8.0 μm |
| Example 2-1 | 107 | HCL-6 | 8 μm | 3.0 μm |
| Comparative | 108 | HCL-7 | 8 μm | 3.0 μm |
| Example 2-1 | | | | |

[Saponification Treatment of Antireflection Film]

After the preparation of light-diffusing film samples, these light-diffusing film samples were subjected to the following treatment.

An aqueous 1.5 mol/liter sodium hydroxide solution was prepared and kept at 55° C. Furthermore, an aqueous 0.01 mol/liter dilute sulfuric acid solution was prepared and kept at 35° C. The produced antireflection film was dipped in the aqueous sodium hydroxide solution for 2 minutes and then dipped in water to thoroughly wash out the aqueous sodium hydroxide solution. Subsequently, the sample was dipped in the aqueous dilute sulfuric acid solution for 1 minute and then dipped in water to thoroughly wash out the aqueous dilute sulfuric acid solution. Finally, the sample was thoroughly dried at 120° C.

[Evaluation of Light-Diffusing Film]

(1) Average Reflectance

The spectral reflectance of each light-diffusing film sample at an incident angle of 5° in the wavelength region of 380 to 780 nm was measured by using a spectrophotometer (manufactured by JASCO Corp.). The average reflectance at 450 to 650 nm was used for the result.

(2) Evaluation of Steel Wool (SW) Rubbing Resistance

A rubbing test of each light-diffusing film sample was performed by using a rubbing tester under the following conditions. Conditions of evaluation environment: 25° C. and 60% RH

Rubbing material:

A steel wool {“Grade No. 0000”, produced by Nippon Steel Wool K.K.} was wound around the tester at the rubbing tip (1 cm×1 cm) coming into contact with the sample and fixed by a band not to move.

Moving distance (one way): 13 cm

Rubbing rate: 13 cm/sec

Load: 1.96N/cm²

Contact area of tip: 1 cm×1 cm

Number of rubbings: 10 reciprocations

An oily black ink was applied to the back side of the rubbed sample, and scratches in the rubbed portion were observed by the reflected light with an eye and evaluated according to the following criteria.

⊚: Scratches were not present at all even when very carefully observed.

ο: Faint scratches were slightly present when very carefully observed.

οΔ: Faint scratches were observed.

Δ: Scratches of medium degree were observed.

Δx-x: Scratches were observed at a glance.

(3) Evaluation of Pencil Hardness

As the index for scratch resistance, the evaluation of pensile hardness described in JIS K 5400 was performed. The light-diffusing film was subjected to moisture conditioning at a temperature of 25° C. and a humidity of 60% RH for 2 hours, and the test was then performed under a load of 4.9N by using a 2H, 3H, 4H or 5H pencil for test prescribed in JIS S 6006. The hardness was evaluated according to the following criteria, and the highest hardness when rated “OK” was used as the evaluation value.

OK: from 0 to 1 scratch in the evaluation of n=5

NG: 3 or more scratches in the evaluation of n=5

(4) Marker Wipability

The light-diffusing film samples each was fixed on a glass surface with a pressure-sensitive adhesive, and a circle having a diameter of 5 mm was written thereon in three turns with a pen tip (fine) of a black marker, “Macky Gokuboso” (trade name, produced by ZEBRA Co.), under the conditions of 25° C. and 60% RH and after 5 seconds, wiped off with a 10-ply folded and bundled Bencot (trade name, produced by Asahi Kasei Corp.) by moving back and forth the bundle 20 times under a load enough to put a dent on the Bencot bundle. The writing and wiping were repeated under the above-described conditions until the marker stain could not be eliminated by the wiping. The number of repetitions where the marker stain could be wiped off was determined. This test was repeated four times and the average of these tests was rated on the following 5-stage scale.

⊚: The marker can be wiped off 10 times or more; the marker stain can be easily eliminated.

Δ: The marker can be wiped off 10 times or more; the marker stain is slightly difficult to eliminate.

Δ: The marker can be wiped off from several times to less than 10 times.

x: The marker can be wiped off only once.

xx: The marker cannot be wiped off even once.

(5) Contact Angle

Using a contact angle meter [“CA-X” Model Contact Angle Meter, manufactured by Kyowa Interface Science Co., Ltd.] in a dry state (20° C./65% RH), a liquid drop in a diameter of 1.0 mm was taken on a needlepoint by using pure water as the liquid and contacted with the film surface to form a liquid drop on the film. Out of the angles between the tangent line with respect to liquid surface and the film surface at the point of the film and the liquid being in contact, the angle on the side including the liquid is defined as the contact angle.

(6) Haze

The entire haze (H), internal haze (Hi) and surface haze (Hs) of the obtained film were determined by the following measurements.

1. The entire haze value (H) of the obtained film was measured according to JIS-K7136.

2. After adding several silicone oil drops on the front and back surfaces of the light-diffusing layer of the obtained film, the film was sandwiched from front and back by two 1 mm-thick glass plates (Microslide Glass No. S 9111, produced by Matsunami K.K.) and put into optically complete contact with two glass plates to provide a surface haze-removed state, and the haze was measured. From this measured value and the haze separately measured by interposing only a silicone oil between two glass plates, the internal haze (Hi) was calculated.

3. The surface haze (Hs) of the film was determined by subtracting the internal haze (Hi) calculated in 2 above from the entire haze (H) measured in 1 above.

TABLE 2

| | Sample | Reflectance | SW Rubbing | Pencil | Marker | Contact | Surface | Internal |
|---|---|---|---|---|---|---|---|---|
| | No. | (%) | Resistance | Hardness | Wipability | Angle | Haze | Haze |
| Example 1-1 | 101 | 2.2 | ◯ | 3H | ◯ | 101° | 5% | 28% |
| Comparative | 102 | 2.2 | Δ | 3H | X | 85° | 5% | 28% |
| Example 1-1 | | | | | | | | |
| Example 1-2 | 103 | 2.9 | ◯ | 4H | ◯ | 103° | 3% | 32% |
| Example 1-3 | 104 | 3.2 | ⊚ | 5H | ⊚ | 105° | 1% | 36% |
| Example 1-4 | 105 | 3.2 | ⊚ | 5H | ⊚ | 105° | 1% | 42% |
| Example 1-5 | 106 | 3.2 | ⊚ | 5H | ⊚ | 105° | 1% | 35% |
| Example 2-1 | 107 | 3.8 | ⊚ | 3H | ⊚ | 101° | 0% | 60% |
| Comparative | 108 | 2.8 | ◯ | 3H | X | 85° | 0% | 60% |
| Example 2-1 | | | | | | | | |

The results shown in Table 2 reveal the followings.

The light-diffusing film of the present invention (Examples 1-1 to 1-5) formed by applying a coating solution for light-diffusing layer, in which a silicone oil having a polymerizable group is added, is excellent in the mass productivity by virtue of its one-layer structure and assured of high visibility, remarkable resistance against scratching and fouling, and sustained antifouling property.

The light-diffusing film of Example 2-1 is also excellent in the mass productivity by virtue of its one-layer structure and assured of high visibility, remarkable resistance against scratching and fouling, and sustained antifouling property.

<Production of Polarizing Plate>

### Examples 11-1 to 11-5

A 80 μm-thick triacetyl cellulose film (TAC-TD80U, produced by Fuji Photo Film Co., Ltd.) which had been dipped in an aqueous 1.5 mol/liter NaOH solution at 55° C. for 2 minutes, neutralized and then washed with water, was bonded for protection to both surfaces of a polarizer produced by adsorbing iodine to polyvinyl alcohol and stretching the film, and the thus-produced polarizing plate was laminated with each of Light-Diffusing Film Samples 103 to 107 of the present invention of Examples 1-2 to 1-5 and 2-1 to produce a polarizing plate with a light-diffusing film. When a liquid crystal display device was produced by using this polarizing plate and arranging the light-diffusing layer as the outermost surface layer, the liquid crystal display device was reduced in the projection of outside light and/or enlarged in the viewing angle and assured of excellent visibility.

### Example 21-1

A 80 μm-thick triacetyl cellulose film, “TAC-TD80U” {produced by Fuji Photo Film Co., Ltd.} which had been dipped in an aqueous NaOH solution with a concentration of 1.5 mol/liter at 55° C. for 2 minutes, neutralized and then washed with water, and Light-Diffusing Film Sample 103 of Example 1-2 were bonded for protection to both surfaces of a polarizing film produced by adsorbing iodine to polyvinyl alcohol and stretching the film. In this way, a polarizing plate was produced. The thus-produced polarizing plate was laminated to replace the polarizing plate on the viewing side of a liquid crystal display device {where “D-BEF” produced by Sumitomo 3M Ltd., which is a polarizing separation film with a polarization selective layer, is provided between the backlight and the liquid crystal cell) of a note-type personal computer having mounted thereon a transmissive TN liquid crystal display device, such that the antireflection film side became the outermost surface. As a result, a display device with extremely reduced projection of surrounding scene, very high display quality and excellent antifouling property was obtained.

<Liquid Crystal Display Device>

### Examples 31-1 to 31-3

In a transmissive TN liquid crystal cell laminated with each of Light-Diffusing Film Samples 103 to 105 of the present invention, a viewing angle-enlarging film, “Wide View Film SA 12B” {produced by Fuji Photo Film Co., Ltd.} was used for the protective film on the liquid crystal cell side of the polarizing plate on the viewing side as well as for the protective film on the liquid crystal cell side of the polarizing plate on the backlight side, as a result, a liquid crystal display device with a very wide viewing angle in the up/down and light/left directions, remarkably excellent visibility and high display quality was obtained.

### Example 4

[Preparation of Coating Solution for Light-Diffusing Layer]

Coating Solutions (HCL-8) to (HCL-21) for Light-Diffusing Layer were prepared by changing the ratio of the non-volatile component as shown in Table 3. With use of toluene/cyclohexanone=85/10 (by mass) as the diluting solvent, the non-volatile component concentration was adjusted to 35%.

TABLE 3

| No. of Coating | | | Polydimethyl- | | | | | |
|---|---|---|---|---|---|---|---|---|
| Solution for | | | siloxane | | Photopolymerization | | | |
| Light-Diffusing | UV Curing Resin | | Compound | | Initiator | | Light-Diffusing Particle | |
| Layer | Kind | Amount | Kind | Amount | Kind | Amount | Kind | Amount |
| HCL-8 | PGMA(E-1) | 25.0 | — | — | Irg-184 | 3.0 | — | — |
| | TMPTA | 75.0 | | | Rhodosil 2074 | 3.0 | | |
| HCL-9 | PGMA(E-1) | 25.0 | SH-200 | 0.05 | Irg-184 | 3.0 | — | — |
| | TMPTA | 75.0 | | | Rhodosil 2074 | 3.0 | | |
| HCL-10 | PGMA(E-1) | 25.0 | UMS-182 | 0.05 | Irg-184 | 3.0 | — | — |
| | TMPTA | 75.0 | | | Rhodosil 2074 | 3.0 | | |
| HCL-11 | PGMA(E-1) | 25.0 | — | — | Irg-184 | 3.0 | crosslinked polystyrene particle | 3 |
| | TMPTA | 75.0 | | | Rhodosil 2074 | 3.0 | crosslinked acryl/styrene particle | 22 |
| HCL-12 | PGMA(E-1) | 25.0 | SH-200 | 0.05 | Irg-184 | 3.0 | crosslinked polystyrene particle | 3 |
| | TMPTA | 75.0 | | | Rhodosil 2074 | 3.0 | crosslinked acryl/styrene particle | 22 |
| HCL-13 | PGMA(E-1) | 25.0 | UMS-182 | 0.05 | Irg-184 | 3.0 | crosslinked polystyrene particle | 3 |
| | TMPTA | 75.0 | | | Rhodosil 2074 | 3.0 | crosslinked acryl/styrene particle | 22 |
| HCL-14 | PET-30 | 100.0 | SH-200 | 0.05 | Irg-184 | 3.0 | crosslinked polystyrene particle | 3 |
| | | | | | Irg-907 | 1.3 | crosslinked acryl/styrene particle | 22 |
| | | | | | Irg-369 | 0.2 | | |
| HCL-15 | PET-30 | 100.0 | UMS-182 | 0.05 | Irg-184 | 3.0 | crosslinked polystyrene particle | 3 |
| | | | | | Irg-907 | 1.3 | crosslinked acryl/styrene particle | 22 |
| | | | | | Irg-369 | 0.2 | | |
| HCL-16 | PET-30 | 100.0 | X22-164C | 0.05 | Irg-184 | 3.0 | crosslinked polystyrene particle | 3 |
| | | | | | Irg-907 | 1.3 | crosslinked acryl/styrene particle | 22 |
| | | | | | Irg-369 | 0.2 | | |
| HCL-17 | PET-30 | 50.0 | UMS-182 | 0.05 | Irg-184 | 3.0 | crosslinked polystyrene particle | 3 |
| | DPHA | 50.0 | | | Irg-907 | 1.3 | crosslinked acryl/styrene particle | 22 |
| | | | | | Irg-369 | 0.2 | | |
| HCL-18 | PET-30 | 30.0 | UMS-182 | 0.05 | Irg-184 | 3.0 | crosslinked polystyrene particle | 3 |
| | DPHA | 40.0 | | | Irg-907 | 1.3 | crosslinked acryl/styrene particle | 22 |
| | Monomer 1 | 30.0 | | | Irg-369 | 0.2 | | |
| HCL-19 | PET-30 | 10.0 | UMS-182 | 0.05 | Irg-184 | 3.0 | crosslinked polystyrene particle | 3 |
| | DPHA | 40.0 | | | Irg-907 | 1.3 | crosslinked acryl/styrene particle | 22 |
| | urethane | 50.0 | | | Irg-369 | 0.2 | | |
| | acrylate 1 | | | | | | | |
| HCL-20 | PET-30 | 10.0 | UMS-182 | 0.05 | Irg-184 | 3.0 | crosslinked polystyrene particle | 3 |
| | DPHA | 40.0 | | | Irg-907 | 1.3 | crosslinked acryl/styrene particle | 22 |
| | urethane | 50.0 | | | Irg-369 | 0.2 | | |
| | acrylate 1 | | | | Initiator-1 | 0.05 | | |
| HCL-21 | PET-30 | 50.0 | UMS-182 | 0.05 | Irg-184 | 3.0 | crosslinked polystyrene particle | 3 |
| | DPHA | 50.0 | | | Irg-907 | 1.3 | crosslinked acryl/styrene particle | 22 |
| | | | | | Trg-369 | 0.2 | | |
| | | | | | Initiator-2 | 0.05 | | |

In Table 3, the amount of each component indicates the parts by weight.

The components used are as follows.

PGMA (E-1):

Glycidyl group-containing polymer (molecular weight: 12,000, the compound described in Example 1 of JP-A-2005-111756.

TMPTA:

Trimethylolpropane triacrylate (TMPTA, Biscote #295, produced by Osaka Organic Chemical Industry Ltd.).

PET-30:

A mixture of pentaerythritol triacrylate and pentaerythritol tetraacrylate (PET-30, produced by Nippon Kayaku Co., Ltd.).

DPHA:

A mixture of dipentaerythritol pentaacrylate and dipentaerythritol hexaacrylate (DPHA, produced by Nippon Kayaku Co., Ltd.).

Monomer 1:

Isocyanuric acid ethoxy-modified diacrylate (compound shown above).

Urethane Acrylate 1:

A urethane acryl compound obtained by reacting a isocyanate group of hydrogenated xylylene diisocyanate with a hydroxyl group of the acrylic acid ester of pentaerythritol.

SH-200:

Unmodified polydimethylsiloxane (SH-200, trade name, kinetic viscosity: 500 mm²/s, molecular weight: about 10,000, produced by Dow Corning Toray Silicone Co., Ltd.).

UMS-182:

Acryl-modified polydimethylsiloxane, molecular weight: 3,500, Si content: 30.5%, acryl substitution ratio: 18% (UMS-182, trade name, produced by Chisso Corp.).

X22-164C:

Acryl-modified polydimethylsiloxane, molecular weight: about 5,000, Si content: 37.2%, acryl substitution ratio: 2% (X22-164C, trade name, produced by Shin-Etsu Chemical Co., Ltd.).

Irg-184:

Photoradical polymerization initiator (Irgacure 184, trade name, produced by Ciba Specialty Chemicals).

Rhodosil 2074:

Photoacid generator (Rhodosil 2074, trade name, produced by Rhodia Chimie).

Irg-907:

Photoradical polymerization initiator (Irgacure 907, trade name, produced by Ciba Specialty Chemicals).

Irg-369:

Photoradical polymerization initiator (Irgacure 369, trade name, produced by Ciba Specialty Chemicals).

Initiator-1:

Photopolymerization initiator having a dimethylsiloxane moiety (compound described in Example 4 of JP-T-2004-522819).

Initiator-2:

Photopolymerization initiator having a dimethylsiloxane moiety (compound described in Example 7 of JP-T-2004-522819). Crosslinked polystyrene particle:

A particle having an average particle diameter of 7.0 μm used in (HCL-4) of Example 1.

crosslinked acryl/styrene particle:

A particle having an average particle diameter of 7.0 μm used in (HCL-4) of Example 1.

<Production of Light-Diffusing Film>

### Example 4-1

A 1,340 mm-wide and 2,600 m-long triacetyl cellulose film, “TD80U” {produced by Fuji Photo Film Co., Ltd.}, in a roll form was unrolled as the support (substrate), and Coating Solution (HCL-12) for Light-Diffusing Layer, in which the silicone oil having a polymerizable group was added, was coated directly thereon by using a doctor blade and a 50 mm-diameter microgravure roll having a gravure pattern with a line number of 135 lines/inch and a depth of 60 μm under the condition of a transportation speed of 15 m/min and after drying at 60° C. for 150 seconds, irradiated with an ultraviolet ray at an illumination intensity of 400 mW/cm² and an irradiation dose of 500 mJ/cm² by using an air-cooled metal halide lamp of 160 W/cm (manufactured by Eye Graphics Co., Ltd.) while purging the system with nitrogen to keep an oxygen concentration of 0.1 vol % or less, thereby curing the coated layer and forming Light-Diffusing Layer (HC-12). The resulting film was taken up. After the curing, the rotation number of the gravure roll was adjusted so that the light-diffusing layer could have an average thickness of 20.0 μm.

Samples of Examples 4-2 to 4-10 and Comparative Examples 4-1 to 4-4 were produced by changing the kind of the coating solution for light-diffusing layer in the sample of Example 4-1 as shown in Table 4 and making control to give an average thickness of 20.0 μm.

[Evaluation of Light-Diffusing Film]

Using the thus-obtained samples, the following evaluations were performed in addition to the evaluations of

### Example 1

(7) Centerline Surface Roughness (Ra)

The centerline average roughness (Ra) was measured according to JIS-B0601.

(8) Evaluation of Marker Wiping Durability

In the evaluation of (4) Marker Wipability, the number of wipings where the maker could be wiped off was used as the evaluation value. The number of wipings is preferably 10 or more, more preferably 15 or more, and most preferably 20 or more.

The evaluation results are shown in Table 4.

TABLE 4

| | | Coating | | | | | | | | |
|---|---|---|---|---|---|---|---|---|---|---|
| | | Solution | Average | | | | | | | |
| | | for Light- | Film | Contact | | Surface | | | | Marker |
| | Sample | Diffusing | Thickness | Angle | | Haze | Internal | SW Rubbing | Pencil | Wiping |
| | No. | Layer | (μ) | (°) | Ra (μ) | (%) | Haze (%) | Resistance | Hardness | Durability |
| Comparative | 401 | HCL-8 | 20.0 | 80 | 0.010 | 0.1 | 0.3 | ◯Δ | 4H | 0 |
| Example 4-1 | | | | | | | | | | |
| Comparative | 402 | HCL-9 | 20.0 | 100 | 0.010 | 0.1 | 0.3 | ◯ | 4H | 2 |
| Example 4-2 | | | | | | | | | | |
| Comparative | 403 | HCL-10 | 20.0 | 100 | 0.010 | 0.1 | 0.3 | ◯ | 4H | 12 |
| Example 4-3 | | | | | | | | | | |
| Comparative | 404 | HCL-11 | 20.0 | 81 | 0.58 | 35 | 36 | Δ | 4H | 0 |
| Example 4-4 | | | | | | | | | | |
| Example 4-1 | 405 | HCL-12 | 20.0 | 100 | 0.52 | 33 | 36 | ◯Δ | 4H | 1 |
| Example 4-2 | 406 | HCL-13 | 20.0 | 101 | 0.52 | 33 | 36 | ◯Δ | 4H | 6 |
| Example 4-3 | 407 | HCL-14 | 20.0 | 101 | 0.070 | 1 | 36 | ⊚ | 5H | 5 |
| Example 4-4 | 408 | HCL-15 | 20.0 | 103 | 0.070 | 1 | 36 | ⊚ | 5H | 18 |
| Example 4-5 | 409 | HCL-16 | 20.0 | 103 | 0.070 | 1 | 36 | ⊚ | 5H | 12 |
| Example 4-6 | 410 | HCL-17 | 20.0 | 103 | 0.070 | 1 | 36 | ⊚ | 5H | 20 |
| Example 4-7 | 411 | HCL-18 | 20.0 | 103 | 0.070 | 1 | 36 | ⊚ | 5H | 22 |
| Example 4-8 | 412 | HCL-19 | 20.0 | 103 | 0.070 | 1 | 36 | ⊚ | 5H | 22 |
| Example 4-9 | 413 | HCL-20 | 20.0 | 103 | 0.070 | 1 | 36 | ⊚ | 5H | 25 |
| Example 4-10 | 414 | HCL-21 | 20.0 | 103 | 0.070 | 1 | 36 | ⊚ | 5H | 25 |

The results shown in Table 4 reveal the followings.

The samples 405 and 406 of the present invention in which light-diffusing particles are added in the samples 402 and 403 of the comparative examples having a contact angle with water of 90° or more have a light-scattering property and marker wipability. In the samples of the present invention, when the surface roughness is 0.5 μm or less and the surface haze is adjusted to 15% or less, the SW rubbing resistance and marker wipability are improved (comparison of Samples 405 and 406 with Samples 407 and 408).

Also, in the samples containing a polydimethylsiloxane-based compound having an active energy ray-curable group within the molecule are excellent in the marker wiping durability (comparison among Samples 407, 408 and 409). Furthermore, the samples containing an isocyanuric acid ethoxy-modified diacrylate compound or urethane acrylate-based compound as the active energy ray-curable resin (comparison of Sample 408 with Samples 411 and 412) or the samples containing a photopolymerization initiator having interfacial activity (comparison of Sample 408 with Samples 413 and 414) have excellent antifouling durability.

### Example 5

Samples 501 to 505 were produced by changing the thickness of the light-diffusing layer as shown in Table 5 in Sample 410 of Example 4. At the time of changing the film thickness, the film thickness was adjusted by increasing or decreasing the amounts of the ultraviolet curable resin and the photopolymerization initiator while keeping constant the ratio therebetween, without changing the amounts of the polydimethylsiloxane compound and the light-diffusing particle.

The evaluations in accordance with Example 4 were performed and the results are shown in Table 5.

TABLE 5

| | | Average Film | | | | | | | Marker |
|---|---|---|---|---|---|---|---|---|---|
| | Sample | Thickness | Contact | | Surface | Internal | SW Rubbing | Pencil | Wiping |
| | No. | (μ) | Angle (°) | Ra (μ) | Haze (%) | Haze (%) | Resistance | Hardness | Durability |
| Example 5-1 | 501 | 6.0 | 103 | 0.520 | 33 | 36 | ◯Δ | 3H | 8 |
| Example 5-2 | 502 | 12.0 | 103 | 0.220 | 14 | 36 | ⊚ | 4H | 20 |
| Example 5-3 | 503 | 20.0 | 103 | 0.070 | 1 | 36 | ⊚ | 5H | 20 |
| Example 5-4 | 504 | 35.0 | 103 | 0.040 | 0.5 | 36 | ⊚ | 6H | 20 |
| Example 5-5 | 505 | 45.0 | 103 | 0.020 | 0.2 | 36 | ◯ | 7H | 17 |

It is seen from the results shown in Table 5 that the samples having a surface roughness of 0.025 to 0.05, a surface haze of 15 or less and a film thickness of 8.0 to 40.0 μm are excellent in the SW rubbing resistance and the maker wiping durability.

The light-diffusing film of the present invention is a light-diffusing film assured of high visibility, suitability for mass production and excellent resistance against scratching and fouling, and capable of sustaining the antifouling property.

Also, the polarizing plate using the light-diffusing film of the present invention as a surface protective film is excellent in the visibility, scratch resistance and antifouling property and can be massively provided at a low cost.

Furthermore, the image display device of the present invention is equipped with the above-described light-diffusing film or polarizing plate and excellent in the visibility, scratch resistance and antifouling property.

The entire disclosure of each and every foreign patent application from which the benefit of foreign priority has been claimed in the present application is incorporated herein by reference, as if fully set forth.

What is claimed is:

1. A light-diffusing film comprising:
a transparent plastic film substrate; and
a light-diffusing layer comprising at least one kind of active energy ray-cured resin and a light-diffusing particle,
wherein a contact angle with water on a surface, on the side opposite to the transparent plastic film substrate, of the light-diffusing layer is 90° or more.

2. The light-diffusing film as claimed in claim 1,
wherein a compound having at least one of a fluorine atom and a silicon atom and having an active energy ray-polymerizable group, the compound being localized in vicinity to the surface of the light-diffusing layer, is connected to the active energy ray-cured resin by a reaction of the active energy ray-polymerizable group.

3. The light-diffusing film as claimed in claim 2,
wherein the compound having the silicon atom and having an active energy-ray polymerizable group is a compound having a polydimethylsiloxane skeleton.

4. The light-diffusing film as claimed in claim 2,
wherein the compound having at least one of a fluorine atom and a silicon atom and having an active energy ray-polymerizable group is represented by formula (1):
Formula (1): 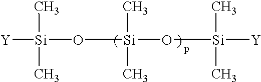
wherein two Ys each independently represents a substituent, p represents an integer of 10 to 1,500, and from 10 to 25% of the two Ys and methyl groups connected to Si atoms are substituted by an alkyl group containing a (meth)acrylate group.

5. The light-diffusing film as claimed in claim 3,
wherein the compound having a polydimethylsiloxane skeleton is an active energy ray-curable silicone resin having a silicon content of 23 to 32 wt %.

6. The light-diffusing film as claimed in claim 3,
wherein the compound having a polydimethylsiloxane skeleton is used in an amount of 0.001 to 0.5 mass % based on the total amount of an active ray-curable resin used for forming the active energy ray-cured resin.

7. The light-diffusing film as claimed in claim 1,
wherein the light-diffusing layer comprises from 3 to 35 parts by mass of a light-diffusing particle per 100 parts by mass in the total solid content of the light-diffusing layer

8. The light-diffusing film as claimed in claim 1,
wherein an average film thickness of the light-diffusing layer is from 8.0 to 40.0 μm.

9. The light-diffusing film as claimed in claim 1, which has a pencil hardness with a load of 4.9N is 3H or more.

10. The light-diffusing film as claimed in claim 1, which has a surface haze of 15% or less.

11. The light-diffusing film as claimed in claim 1, which has an internal haze of from 10 to 70%.

12. A polarizing plate comprising:
a polarizing film; and
two protective films on both sides of the polarizing film,
wherein at least one of the two protective films is the light-diffusing film claimed in claim 1.

13. The polarizing plate comprising:
a polarizing film; and
two protective films on both sides of the polarizing film,
wherein one of the two protective films is the light-diffusing film claimed in claim 1, and
the other one of the two protective films is an optical compensation film having optical anisotropy.

14. An image display device comprising:
an image display; and
the light-diffusing film claimed in claim 1, disposed on a surface of the image display.

15. An image display device comprising:
an image display; and
the polarizing plate claimed in claim 12, disposed on a surface of the image display.

16. The image display device as claimed in claim 14,
wherein the image display device is a transmissive, reflective or transflective liquid crystal display device in any one mode of TN, STN, IPS, VA and OCB.

17. The image display device as claimed in claim 15, wherein the image display device is a transmissive, reflective or transflective liquid crystal display device in any one mode of TN, STN, IPS, VA and OCB.
